(19) United States
(12) Patent Application Publication
(10) Pub. No.: US 2017/0199661 A1
(43) Pub. Date: Jul. 13, 2017

(54) METHOD OF CHARACTER SELECTION THAT USES MIXED AMBIGUOUS AND UNAMBIGUOUS CHARACTER IDENTIFICATION

(71) Applicant: Michael William Murphy, Bellingham, WA (US)

(72) Inventor: Michael William Murphy, Bellingham, WA (US)

(21) Appl. No.: 15/274,577

(22) Filed: Sep. 23, 2016

Related U.S. Application Data
(60) Provisional application No. 62/276,729, filed on Jan. 8, 2016.
(60) Provisional application No. 62/318,125, filed on Apr. 4, 2016.
(60) Provisional application No. 62/334,702, filed on May 11, 2016.

(51) Int. Cl. G06F 3/0488; G06F 17/27; G06F 3/0482

(52) U.S. Cl. CPC G06F 3/04883; G06F 3/0482; G06F 3/04886; G06F 17/2735; G06F 17/276

(57) ABSTRACT

Systems, devices and methods are disclosed for selection of characters from a menu using button presses and button presses that incorporate swipe gestures. In one embodiment, a button press ambiguously identifies a pair of characters in the menu. In a further embodiment, a press of the same button, but that incorporates a swipe gesture, unambiguously identifies a character adjacent to said pair. In a further embodiment, button presses are time dependent and button presses that incorporate swipe gestures are time independent. In a further embodiment, a button press lasting longer than a given time threshold unambiguously identifies a character of the character pair. In yet a further embodiment, the direction of a swipe gesture incorporated in a button press unambiguously identifies a character from several characters adjacent to the pair. Sequences of mixed ambiguous and unambiguous selections are compared with a dictionary to identify a possible intended word.

### BACKGROUND

### Technical Field

This description generally relates to the field of electronic devices and, more particularly, to user interfaces of electronic devices.

### BRIEF SUMMARY

Mobile text input is notoriously slow, inaccurate and inconvenient. To make text input easier, a novel computer-processor implemented method and interface is proposed that reduces the dexterity needed to type. The interface eases text input by offering large selection buttons and selection gestures that are resistant to input errors but still intuitive.

Characters are presented to the user in a menu. The characters are arranged in rows. Each character is either a member of a character pair or corresponds with an indicator that separates the character pairs.

Selection buttons are arranged in rows that correspond to the character rows of the menu. Within a row, each selection button corresponds to one character pair.

To select a character, a user executes either a button press or a swipe gesture. To select a character that's a member of a character pair, a user presses the selection button that corresponds with the character pair. To select a character that corresponds with an indicator, a user presses a selection button that corresponds with a character pair next to the indicator then swipes in the direction of the indicator relative to the character pair that corresponds with the pressed button.

Following a sequence of selections, a press of the spacebar launches a disambiguation algorithm. The disambiguation algorithm attempts to identify a word made up of one letter from each character pair selected via button press and the letters selected by character swipes, in the order that the selections were made. Comparison of candidate sequences with a dictionary determines if one, more than one, or no words correspond to the received sequence. In one embodiment, the word most likely intended by the user is chosen based on various probabilities, such as each candidate word's frequency-of-use in language and the likelihood of input gesture errors that lead to the word candidate. In an alternative embodiment of the algorithm, the search for a word match begins even before the user completes the sequence of selections.

One characteristic of the input gestures is that button presses are time dependent while button presses that incorporate a swipe gesture are time independent. A further optional characteristic is that a time dependent button press can be unambiguous for one of the two characters of the character pair. In one embodiment, a button press lasting shorter than some time threshold ambiguously identifies the characters of the pair, but a press lasting longer than the time threshold unambiguously identifies one character of the pair, such as the second (or right-hand) character of the pair. “Ambiguous” as used herein refers to an example embodiment wherein the button press lasting shorter than some time threshold indicates the character ultimately selected will be one of the characters in the pair of characters, although it is not known which will be ultimately selected until the button press ends, not that the overall character selection process is ambiguous or unclear.

A user interface having a character menu and selection buttons enables the method described above by assigning values to the position of characters in their menu row and corresponding values to the buttons that select the characters of the menu. In one embodiment, characters of the menu are identified consecutively based on their position in the menu row, for example consecutively from left to right starting from 0. In a further embodiment, selection buttons are assigned values incrementally, for example every third value (0, 3, 6, and so on).

In one embodiment of the method, a button press lasting less than some time threshold ambiguously selects the characters of the pair that correspond to the pressed selection button. In a further embodiment, a button press lasting longer than some time threshold unambiguously selects one of the characters of the pair that corresponds to the pressed selection button. In a further embodiment, a button press that incorporates a swipe gesture unambiguously selects a character adjacent to the pair that corresponds with the selection button with which the swipe is executed and is positioned relative to the pair in a direction that corresponds with the direction of the swipe.

In still a further embodiment, the button press lasting less than the time threshold ambiguously selects the characters in the menu positions that correspond with the assigned value of the selection button and with the character one position greater than the assigned value of the selection button, respectively. In still a further embodiment, the button press lasting longer than the time threshold unambiguously selects the character one menu position greater than the assigned value of the selection button. In yet a further embodiment, a swipe in one direction selects the character one menu position less than the position that corresponds to the value of the selection button with which the swipe is executed. In still a further embodiment, a swipe in an opposite direction selects the character two menu positions greater than the position that corresponds to the value of the selection button with which the swipe is executed.

In another embodiment, a computer processor-implemented method may be summarized as including: identifying, by at least one computer processor, a character pair from among a menu of displayed characters in response to activation of a button; if input is received, by the at least one computer processor, indicative of a swipe gesture being incorporated in the activation of the button: determining, by the at least one computer processor, a direction of the swipe gesture; identifying by the at least one computer processor, a character adjacent in the menu to the character pair based on the determined direction of the swipe gesture; and interpreting, by the at least one computer processor, the identified character or character pair as input.

The method may further include: acquiring, by the at least one computer processor, a sequence of interpreted characters and character pairs; and disambiguating, by the at least one computer processor, the acquired sequence by evaluating alternative combinations of the characters and one letter from each of the character pairs in the order that the characters and character pairs are acquired to find a known word. The method may further include the at least one computer processor using input indicative of the duration of the button activation to unambiguously identify one character of the character pair if input is not received indicative of a swipe gesture being incorporated in the activation of the button. The method may further include: the at least one computer processor using input indicative of a button activation lasting less than or equal to a particular time period to identify the character pair; and the at least one computer processor using input indicative of a button activation lasting greater than the particular time period to identify one character of the character pair. The method may further include: the at least one computer processor using input indicative of a button activation being absent an incorporated swipe gesture to identify a character dependent on a duration of the button activation; and the at least one computer processor using input indicative of another button activation of the button incorporating a swipe gesture to identify a character independent of a duration of the other button activation. The method may further include the at least one computer processor using correspondence of a value assigned to the activated button with a value assigned to a position of a character in the menu of displayed characters to identify the character whose position is assigned to the value upon onset of activation of the button. The method may further include the at least one computer processor using input indicative of activation of the button lasting greater than a particular time period to identify a character of the character pair in a menu position one greater than the assigned value of the activated button. The identifying, by the at least one computer processor, a character adjacent in the menu to the character pair based on the determined direction of the swipe gesture may include: if the at least one computer processor determines the direction of the swipe gesture is in a first direction, then identifying, by the at least one computer processor, a character in the menu at a position in the menu having an assigned value one less than the assigned value of the activated button; and if the at least one computer processor determines the direction of the swipe gesture is in a second direction different than the first direction, then the at least one computer processor identifying, by the at least one computer processor, a character in the menu at a position in the menu having an assigned value two greater than the assigned value of the activated button. The method may further include the at least one computer processor interpreting character input resulting from activation of a plurality of selection buttons, including the activated button, which have assigned values that occur in increments of 3. The identifying, by the at least one computer processor, a character adjacent in the menu to the character pair based on the determined direction of the swipe gesture may include: if the at least one computer processor determines the direction of the swipe gesture is in a first direction, identifying, by the at least one computer processor, a first character adjacent in the menu to the character pair; and if the at least one computer processor determines the direction of the swipe gesture is in a second direction, identifying, by the at least one computer processor, a second character adjacent in the menu to the character pair. The first direction and second direction may be opposing directions.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic view of an example electronic device for input of characters with time-dependent button presses and time-independent swipe gestures according to one illustrated embodiment, the electronic device being a mobile device having a housing, a display, a graphics engine, a central processing unit (CPU), user input device(s), one or more storage mediums having various software modules thereon that are executable by the CPU, input/output (I/O) port(s), network interface(s), wireless receiver(s) and transmitter(s), a power source, an elapsed time counter, an integer value counter and a swipe gesture interpreter.

FIG. 2 is a schematic drawing of one embodiment of the electronic device 100 for input of characters.

FIG. 3 is a flow diagram that shows a method for specifying a character from among a plurality of characters according to one illustrated embodiment.

FIG. 4 is a plot of graphical representations of possible examples of responses of input gestures.

FIG. 5 is a flow diagram that shows a method for an electronic device to interpret button presses according to one illustrated embodiment.

FIG. 6 is a graphical representation of a response for an example input gesture for one embodiment of a user interface.

FIG. 7 is another graphical representation of a response for an example input gesture for one embodiment of a user interface.

FIG. 8 is still another graphical representation of a response for an example input gesture for one embodiment of a user interface.

FIG. 9 is yet another graphical representation of a response for an example input gesture for one embodiment of a user interface.

FIG. 10 is a schematic drawing of another embodiment of the electronic device 100 for input of characters.

FIG. 11 is a plot of additional graphical representations of possible examples of responses of input gestures.

FIG. 12 is a flow diagram that shows another method for an electronic device to interpret button presses according to one illustrated embodiment.

FIG. 13 is a table of possible values and variables for a method of interpreting input according to one possible selection button.

FIG. 14 is a table of more possible values and variables for a method of interpreting input according to one possible set of selection buttons.

FIGS. 15A and 15B are flow diagrams that show still another method for an electronic device to interpret button presses according to one illustrated embodiment.

FIG. 16 is a table of possible variable combinations for a method of interpreting button presses according to one illustrated embodiment.

FIG. 17 is a table of value assignments, a user interface and a list of variables for one embodiment of a method of character identification.

FIG. 18 is an example of an application of a method of character identification.

FIG. 19 is another example of an application of a method of character identification.

FIG. 20 is a schematic drawing of yet another embodiment of the electronic device 100 for input of characters.

FIG. 21 is another table of value assignments, a user interface and a list of variables for one embodiment of a method of character identification.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks, including various types of telecommunications networks, have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

Various embodiments are described herein that provide systems, devices and methods for input of characters with optional time-dependent button presses.

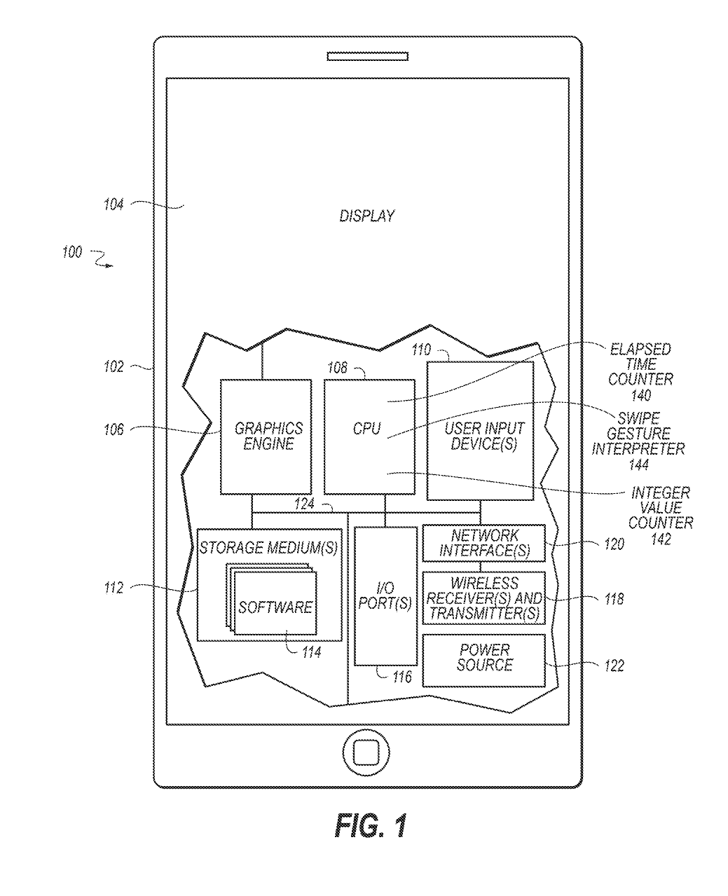

For example, FIG. 1 is a schematic view of one example electronic device, in this case mobile device 100, for input of characters with optional time-dependent button presses according to one illustrated embodiment. The mobile device 100 shown in FIG. 1 may have a housing 102, a display 104, a graphics engine 106, a central processing unit (CPU) 108, one or more user input devices 110, one or more storage mediums 112 having various software modules 114 stored thereon comprising instructions that are executable by the CPU 108, input/output (I/O) port(s) 116, one or more wireless receivers and transmitters 118, one or more network interfaces 120, and a power source 122. In some embodiments, some or all of the same, similar or equivalent structure and functionality of the mobile device 100 shown in FIG. 1 and described herein may be that of, part of or operably connected to a communication and/or computing system of another device or machine.

The mobile device 100 may be any of a large variety of devices such as a cellular telephone, a smartphone, a wearable device, a wristwatch, a portable media player (PMP), a personal digital assistant (PDA), a mobile communications device, a portable computer with built-in or add-on cellular communications, a portable game console, a global positioning system (GPS), a handheld industrial electronic device, a television, an automotive interface, an augmented reality (AR) device, a virtual reality (VR) device or the like, or any combination thereof. The mobile device 100 has at least one central processing unit (CPU) 108 which may be a scalar processor, a digital signal processor (DSP), a reduced instruction set (RISC) processor, or any other suitable processor. The central processing unit (CPU) 108, display 104, graphics engine 106, one or more user input devices 110, one or more storage mediums 112, input/output (I/O) port(s) 116, one or more wireless receivers and transmitters 118, and one or more network interfaces 120 may all be communicatively connected to each other via a system bus 124. The system bus 124 can employ any suitable bus structures or architectures, including a memory bus with memory controller, a peripheral bus, and/or a local bus.

The mobile device 100 also includes one or more volatile and/or non-volatile storage medium(s) 112. The storage mediums 112 may be comprised of any single or suitable combination of various types of processor-readable storage media and may store instructions and data acted on by CPU 108. For example, a particular collection of software instructions comprising software 114 and/or firmware instructions comprising firmware are executed by CPU 108. The software or firmware instructions generally control many of the operations of the mobile device 100 and a subset of the software and/or firmware instructions may perform functions to operatively configure hardware and other software in the mobile device 100 to provide the initiation, control and maintenance of applicable computer network and telecommunication links from the mobile device 100 to other devices using the wireless receiver(s) and transmitter(s) 118, network interface(s) 120, and/or I/O ports 116.

The CPU 108 includes an elapsed time counter 140. The elapsed time counter 140 may be implemented using a timer circuit operably connected to or as part of the CPU 108. Alternately some or all of the elapsed time counter 140 may be implemented in computer software as computer executable instructions stored on volatile and/or non-volatile storage medium(s) 112, for example, that when executed by CPU 108 or a processor of a timer circuit, performs the functions described herein of the elapsed time counter 140.

The CPU 108 includes an integer value counter (also called button press value counter) 142. Alternately, some or all of the integer value counter 142 may be implemented in computer software as computer executable instructions stored on volatile and/or non-volatile storage medium(s) 112, for example, that when executed by CPU 108, performs the functions described herein of the integer value counter 142.

The CPU 108 includes a swipe gesture interpreter 144. Alternately, some or all of the swipe gesture interpreter 144 may be implemented in computer software as computer executable instructions stored on volatile and/or non-volatile storage medium(s) 112, for example, that when executed by CPU 108, performs the functions described herein of the swipe gesture interpreter 144.

By way of example, and not limitation, the storage medium(s) 112 may be processor-readable storage media which may comprise any combination of computer storage media including volatile and nonvolatile, removable and non-removable media implemented in any method or technology for storage of information such as computer readable instructions, data structures, program modules or other data. Combinations of any of the above should also be included within the scope of processor-readable storage media. The storage medium(s) 112 may include system memory which includes computer storage media in the form of volatile and/or nonvolatile memory such as read-only memory (ROM) and random access memory (RAM). A basic input/output system (BIOS), containing the basic routines that help to transfer information between elements within mobile device 100, such as during start-up or power-on, is typically stored in ROM. RAM typically contains data and/or program modules that are immediately accessible to and/or presently being operated on by CPU 108. By way of example, and not limitation, FIG. 1 illustrates software modules 114 including an operating system, application programs and other program modules that implement the processes and methods described herein.

The mobile device 100 may also include other removable/non-removable, volatile/nonvolatile computer storage media drives. By way of example only, the storage medium(s) 112 may include a hard disk drive or solid state storage drive that reads from or writes to non-removable, nonvolatile media, a SSD that reads from or writes to a removable, nonvolatile SSD, and/or an optical disk drive that reads from or writes to a removable, nonvolatile optical disk such as a DVD-RW or other optical media. Other removable/non-removable, volatile/nonvolatile computer storage media that can be used in an operating environment of the mobile device 100 include, but are not limited to, flash memory cards, other types of digital versatile disks (DVDs), micro-discs, digital video tape, solid state RAM, solid state ROM, and the like. The storage medium(s) are typically connected to the system bus 124 through a non-removable memory interface. The storage medium(s) 112 discussed above and illustrated in FIG. 1 provide storage of computer readable instructions, data structures, program modules and other data for the mobile device 100. In FIG. 1, for example, a storage medium may store software 114 including an operating system, application programs, other program modules, and program data. The storage medium(s) 112 may implement a file system, a flat memory architecture, a database, or any other method or combination capable for storing such information.

A user may enter commands and information into the mobile device 100 through touch screen display 104 or the one or more other input device(s) 110 such as a keypad, keyboard, tactile buttons, camera, motion sensor, position sensor, light sensor, biometric data sensor, accelerometer, or a pointing device, commonly referred to as a mouse, trackball or touch pad. Other input devices of the mobile device 100 may include a microphone, joystick, thumbstick, game pad, optical scanner, other sensors, or the like. Furthermore the touch screen display 104 or the one or more other input device(s) 110 may include sensitivity to swipe gestures, such as a user dragging a finger tip across the touch screen display 104. The sensitivity to swipe gestures may include sensitivity to direction and/or distance of the swipe gesture. These and other input devices are often connected to the CPU 108 through a user input interface that is coupled to the system bus 124, but may be connected by other interface and bus structures, such as a parallel port, serial port, wireless port, game port or a universal serial bus (USB). Generally, a unique software driver stored in software 114 configures each input mechanism to sense user input, and then the software driver provides data points that are acted on by CPU 108 under the direction of other software 114. The display is also connected to the system bus 124 via an interface, such as the graphics engine 106. In addition to the display 104, the mobile device 100 may also include other peripheral output devices such as speakers, a printer, a projector, an external monitor, etc., which may be connected through one or more analog or digital I/O ports 116, network interface(s) 120 or wireless receiver(s) and transmitter(s) 118. The mobile device 100 may operate in a networked environment using connections to one or more remote computers or devices, such as a remote computer or device.

When used in a LAN or WAN networking environment, the mobile device 100 may be connected via the wireless receiver(s) and transmitter(s) 118 and network interface(s) 120, which may include, for example, cellular receiver(s) and transmitter(s), Wi-Fi receiver(s) and transmitter(s), and associated network interface(s). When used in a WAN networking environment, the mobile device 100 may include a modem or other means as part of the network interface(s) for establishing communications over the WAN, such as the Internet. The wireless receiver(s) and transmitter(s) 118 and the network interface(s) 120 may be communicatively connected to the system bus 124. In a networked environment, program modules depicted relative to the mobile device 100, or portions thereof, may be stored in a remote memory storage device of a remote system.

The mobile device 100 has a collection of I/O ports 116 and/or short range wireless receiver(s) and transmitter(s) 118 and network interface(s) 120 for passing data over short distances to and from the mobile device 100 or for coupling additional storage to the mobile device 100. For example, serial ports, USB ports, Wi-Fi ports, Bluetooth® ports, IEEE 1394 (i.e., FireWire), and the like can communicatively couple the mobile device 100 to other computing apparatuses. Compact Flash (CF) ports, Secure Digital (SD) ports, and the like can couple a memory device to the mobile device 100 for reading and writing by the CPU 108 or couple the mobile device 100 to other communications interfaces such as Wi-Fi or Bluetooth transmitters/receivers and/or network interfaces. Mobile device 100 also has a power source 122 (e.g., a battery). The power source 122 may supply energy for all the components of the mobile device 100 that require power when a traditional, wired or wireless power source is unavailable or otherwise not connected. Other various suitable system architectures and designs of the mobile device 100 are contemplated and may be utilized which provide the same, similar or equivalent functionality as those described herein.

It should be understood that the various techniques, components and modules described herein may be implemented in connection with hardware, software and/or firmware or, where appropriate, with a combination of such. Thus, the methods and apparatus of the disclosure, or certain aspects or portions thereof, may take the form of program code (i.e., instructions) embodied in tangible media, such as various solid state memory devices, DVD-RW, RAM, hard drives, flash drives, or any other machine-readable or processor-readable storage medium wherein, when the program code is loaded into and executed by a machine, such as a processor of a computer, vehicle or mobile device, the machine becomes an apparatus for practicing various embodiments. In the case of program code execution on programmable computers, vehicles or mobile devices, such generally includes a processor, a storage medium readable by the processor (including volatile and non-volatile memory and/or storage elements), at least one input device, and at least one output device. One or more programs may implement or utilize the processes described in connection with the disclosure, e.g., through the use of an API, reusable controls, or the like. Such programs are preferably implemented in a high level procedural or object oriented programming language to communicate with a computer system of mobile device 100. However, the program(s) can be implemented in assembly or machine language, if desired. In any case, the language may be a compiled or interpreted language, and combined with hardware implementations.

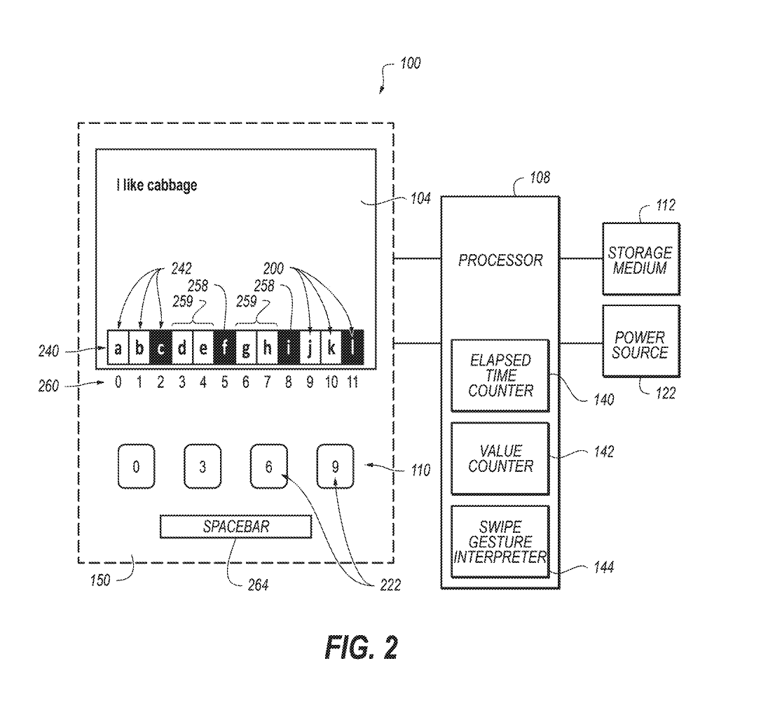

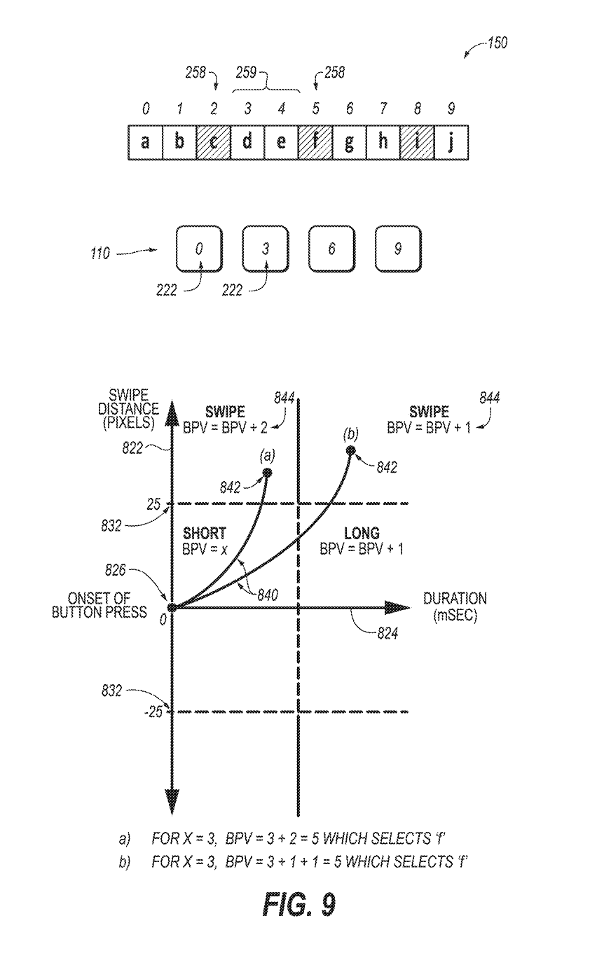

FIG. 2 shows a schematic drawing of one embodiment of the electronic device 100 for input of characters. The device 100 may have some or all the components and functionality described herein with respect to the mobile device 100 of FIG. 1. The device 100 has aspects previously disclosed in FIG. 9 of U.S. Pat. No. 8,487,877, which is hereby incorporated by reference in its entirety.

The electronic device 100 includes the display 104, a plurality of characters 200 that populate positions 242 of a character menu 240, a plurality of selection buttons 110 and a spacebar button 264, which together make up a user interface 150 of the device 100. Each of the plurality of selection buttons 110 has an assigned button press value 222. Included as part or within proximity to the menu 240 is at least one reference indicator 258 and an offset scale 260. The display 104, the plurality of selection buttons 110, and the spacebar button 264 are communicatively coupled with the CPU 108, as described in the embodiment of FIG. 1. The CPU 108 includes the elapsed time counter 140, the integer value counter 142 and the swipe gesture interpreter 144, as described in the embodiment of FIG. 1. The CPU 108 is communicatively coupled with the storage medium 112 and the power source 122, as described in the embodiment of FIG. 1.

In the embodiment of FIG. 2, the positions 242 of the menu 240 are arranged in a one-dimensional array similar to the embodiment in FIG. 9 of U.S. Pat. No. 8,487,877, except that the menu 240 and corresponding selection buttons 110 are shown on the display 104 instead of as physical features of the user interface 150. The buttons 110 are communicatively coupled with the CPU 108.

The menu 240 and the offset scale 260 are positioned in respective one-dimensional arrays in the user interface region 150 of the device 100. In one embodiment the character menu 240 and the offset scale 260 are positioned on the user interface 150 so that they lie adjacent to and parallel with one other. In one embodiment, the character menu 240 and the offset scale 260 are programmed in software so that they appear as features on the display 104 of the device 100.

In one embodiment, positions 242 of the menu 240 are distributed in a one-dimensional array in evenly spaced increments. In a further embodiment, values of the offset scale 260 are distributed in a one-dimensional array in spatial increments that match the increment of the menu 240, so that by referencing the offset scale 260 to the menu 240, characters 200 in the menu are effectively numbered.

The at least one reference indicator 258 is located near or on one of the positions 242 of the menu 240. In one embodiment, the offset scale 260 includes a value of zero that is located at the end most position of the menu 240. Values of the offset scale 260 increase from zero in pre-selected increments as positions of the offset scale get farther from the zero value. In a further embodiment, the pre-selected increment of the offset scale 260 equals one and the values of the offset scale increase from zero. In an alternative embodiment, the increment of the offset scale 260 is 10 and positions 242 of the menu 240 are marked off in corresponding units of 10.

In one specific embodiment, the positions 242 of the menu 240 and the values of the offset scale 260 are distributed in respective one-dimensional arrays positioned adjacent to and parallel with one another, the values of the offset scale 260 count in increments of one and are spaced with respect to one another in their array to correspond with the spacing of positions 242 of the menu 240, and the zero value of the offset scale 260 corresponds to the left-most position of the menu 240 so that the values of the offset scale 260 label the positions of the menu 240 according to how many positions a given position 242 of the menu 240 is offset from the left-most position. In still a further embodiment, the menu includes multiple reference indicators 258. In a further embodiment, the multiple reference indicators 258 occur at every third position 242 of the menu 240. In such an embodiments, the reference indicators 258 demarcate character pairs 259. In yet a further embodiment the reference indicators 258 identify the menu positions 2, 5, 8 and 11. In such an embodiment, the reference indicators demarcate characters pairs 259 in the positions 0-1, 3-4, 6-7, and 9-10.

The plurality of selection buttons 110 lie on the display 104 of the user interface 150 of the device 100. In one embodiment, the buttons 110 are arranged in a row that corresponds to the physical alignment of the menu 240 on the user interface. Each button is communicatively coupled with the CPU 108 and is assigned a button press value 222. Each button 110 has the function that when the button is pressed the value 222 assigned to the button is input to the CPU 108. Furthermore, each button 110 also has the function that when pressed longer than some pre-selected time duration, the assigned value 222 input to the CPU 108 at the onset of the button press becomes updated. In one embodiment the update occurs according to a predetermined mathematical function. Furthermore, each button 110 also has the function that when a swipe gesture occurs during the course of the press, the assigned value 222 input to the CPU 108 at the onset of the button press becomes updated. In one embodiment the update occurs according to a predetermined mathematical function.

In one embodiment, the values 222 assigned to the selection buttons 110 are multiples of 3. In another embodiment there are four selection buttons and the buttons' assigned values are 0, 3, 6, and 9. In another embodiment, each selection button value corresponds with the position of a character of a character pair 259. In yet another embodiment there are four selection buttons and the buttons' assigned values are 0, 3, 6, 8 and 11.

The spacebar 264 also lies in the user interface region 150 of the device 100, can be either a hard or soft key, and is communicatively coupled with the CPU 108.

In one embodiment, such as shown in FIG. 2, the menu 240 has 12 menu positions 242 and four reference indicators 258. In a further embodiment, the interface includes four selection buttons 110. In still a further embodiment, the menu positions 242 are numbered from 0 to 11, the four reference indicators 258 correspond to menu positions 2, 5, 8 and 11 which demarcate character pairs at positions 0-1, 3-4, 6-7, and 9-10, and the assigned button press values 222 are 0, 3, 6, and 9. In a further embodiment, the menu positions 242 are populated by 12 of the 26 characters 200 of the English alphabet.

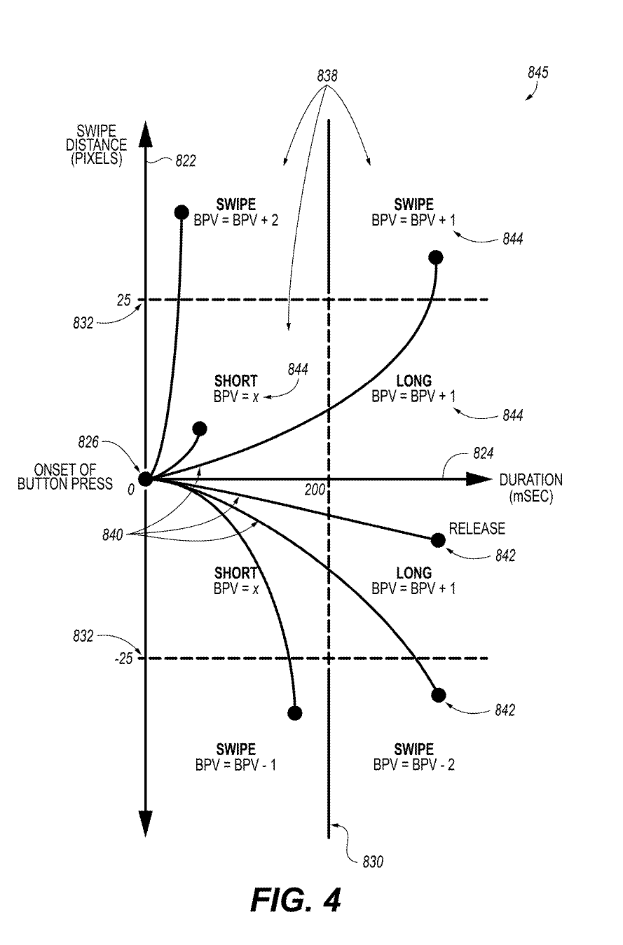

The selection buttons 110 of the electronic device 100 of FIG. 2 are receptive to two input gestures: button presses and swipe gestures. A ‘button press’ is an activation of a button that extends for some duration of time greater than zero. A ‘swipe gesture’ is a positional displacement of a button press along the screen 104 that occurs during a button press. As will be discussed in FIG. 4, a swipe gesture includes the possibility of a zero-length displacement. Based on these two definitions, any activation of one of the selection buttons 110 includes both a ‘button press’ and a ‘swipe gesture’.

The duration of a button press is measured from the onset of the button press until its release. The duration is typically measured in milliseconds. The positional displacement (also called length or distance) of a swipe gesture is measured along the plane of the screen 104 from the point of the button press at its onset to the point of the button press at its release. The swipe distance is typically measured in pixels, but can also be measured in other length units such as mm or fractional inches.

Although duration and swipe distance are measured responses to separate input gestures (button press and swipe gesture, respectively), both input gestures are inherent in any button activation. In other words, for the gestures as they are defined above, any button activation includes both a button press and swipe gesture (even if the swipe distance equals 0). As such, the response of each input gesture can be acquired simultaneously for any button activation.

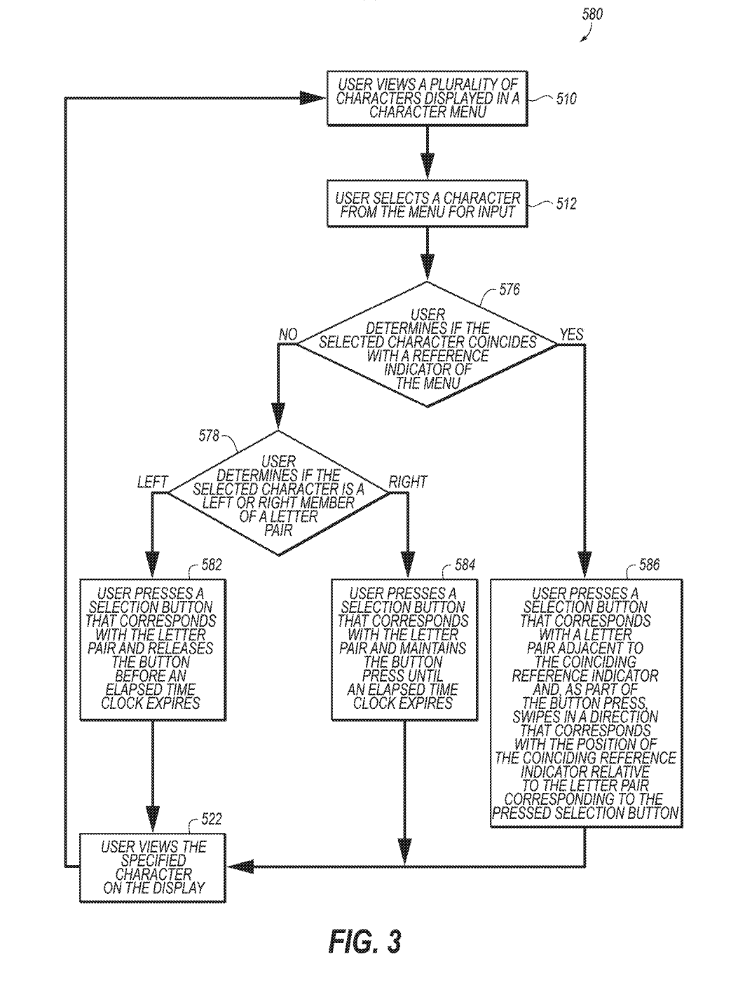

FIG. 3 shows a flowchart of an embodiment of a method 580 for a user to specify a character from among a plurality of characters. In one step 510 of the method 580, a user views the characters 200 displayed in the menu 240. In another step 512, the user selects a character from the menu 240 for input to the electronic device 100.

In another step 576, the user determines if the position of the selected character corresponds with a reference indicator 258 of the menu or not.

If the user determines the selected character does not correspond with a reference indicator 258 of the menu, then in another step 578, the user determines if the selected character is in a first or second position of a character pair 259. In one embodiment, the first position is the left position of the character and the second position is the right position of the pair.

If the user determines the selected character is in the first position, then in a step 582 the user presses a selection button that corresponds with the character pair and releases the button before a predetermined elapsed time period expires. The aforementioned step 582 inputs the assigned value 222 of the pressed selection button to the button value counter 142, triggers the CPU 108 to start the elapsed time counter 140, and indicates to the CPU that the type of button press is a SHORT press.

However, in the step 578, if the user determines the selected character is in the second position of the character pair 259, then in a step 584 the user presses a selection button that corresponds with the character pair and maintains the button press until the predetermined elapsed time period expires. The aforementioned step 578 inputs the assigned value 222 of the pressed selection button to the button press value counter 142, triggers the CPU 108 to start the elapsed time counter 140, and indicates to the processor that the type of button press is a SHORT press. Then, once the elapsed time counter expires the CPU adds one to the button press value counter and updates the button press type to a LONG press.

However, in the step 576, if the user determines the selected character corresponds with one of the reference indicators 258 of the menu, then in another step 586, the user presses a selection button that corresponds with a character pair adjacent to the said reference indicator 258 and, as part of the button press, swipes in a direction corresponding with the position of said reference indicator relative to the pressed button's corresponding character pair. The aforementioned step 576 inputs the assigned value 222 of the pressed selection button to the button press value counter 142, triggers the CPU 108 to start the elapsed time counter 140, and indicates to the processor that the type of button press is a SHORT press. Then, once the swipe gesture exceeds some predetermined distance threshold, the CPU adds or subtracts a value of one or two to the button press value counter. The math operation (addition or subtraction) and the value (1 or 2) used by the CPU depends on the direction of the swipe and whether the swipe exceeds the distance threshold before or after the time threshold expires—these determinations will be described in further detail in FIG. 4. The CPU also updates the button press type to a SWIPE gesture.

In an optional step 522, the user views the specified character on the display 104. In an alternative embodiment, step 522 is bypassed.

According to another embodiment of the invention, the character specification method 580 described above is used iteratively to specify series' of characters from the character menu 240. In one embodiment, words and sentences are formed on the display 104 by iteratively specifying characters according the method above, with the spacebar 264 used to input spaces between words on the display.

FIG. 4 shows a plot 845 that represents possible examples of responses for duration and swipe distance for the input gestures ‘button press’ and ‘swipe gesture’, respectively. Each curve 840 represents a possible combination of the responses for duration and swipe distance over the course of a character selection cycle (also referred to as button activation).

In the plot, button press duration is plotted on the x-axis 824 and swipe distance on the y-axis 822. Duration is measured in units of milliseconds and swipe distance is measured in units of pixels. The value for swipe distance can be positive or negative and corresponds with the direction of the swipe along the menu row 240. Onset of a button press occurs at the plot's origin 826 and marks the point in time and distance where the onset of an input gesture occurs. The release of a button is represented by a terminus 842 at the end of each curve. The path that a curve 840 follows through the plot reflects the duration and swipe distance of a received button activation.

The response of any input gesture is converted to a binary value by comparing the current terminus of the response with threshold values for duration and swipe distance. The threshold value enables the analog output of each measured response to be recast as a binary output, i.e. a high or low value. A terminus that exceeds a threshold value is a high value; one that falls below the threshold value is a low value.

In the plot 845, the duration axis 824 is divided into two segments by an elapsed time threshold 830, which in this example equals 200 msec. The elapsed time threshold corresponds with the end of a selectable elapsed time period (ETP) mentioned elsewhere throughout this disclosure.

The swipe distance axis 822 is divided into segments by a swipe distance threshold 832, which in this example equals 25 pixels. The swipe distance threshold identifies a minimum positional displacement (positive or negative) for a swipe gesture to be classified as a SWIPE BPT (rather than a LONG or SHORT BPT). The polarity of the swipe distance value indicates the direction of the displacement. This minimum positional displacement may be selectable and may be based on various factors, including display screen size and/or user preferences.

Applying the threshold values 830, 832 to the plot 845 divides the plot into eight regions 838. Each region represents a unique combination of the binary output values from the input gestures. In other words, for the gesture responses ‘button press duration’ and ‘swipe distance’, each region represents one possible combination of high and low values (duration:swipe distance) as follows—low:negative-low, high:negative-low, low:negative-high, high:negative-high, low:positive-low, high:positive-low, low:positive-high, and high:positive-high. For the example of FIG. 4, the measured responses would be distributed among the eight regions as follows: <200:−25<d<0, >200:−25<d<0, <200:d<−25, >200:d<−25, <200:0<d<25, >200:0<d<25, <200:d>25, >200:d>25, where d is the length and direction of the swipe.

Each region 838 of the plot is identified by a button press type (BPT) value. The BPT is merely a label for the combination of binary values that identify a given region. During the course of a character selection cycle, the current BPT value reflects the current measured responses for duration and swipe distance. Because the path that a curve 840 takes through the plot may intersect more than one region 838 of the plot during the course of a character selection cycle, the BPT may evolve during the selection cycle. The final BPT value of a character selection cycle is determined when the button press is lifted, which is identified by the terminus 842 of the curve. For the embodiment of FIG. 4, the possible BPTs are SHORT, LONG and SWIPE.

Each region 838 of the plot also has an associated math operation 844. The math operation is a calculation that the processor 108 executes on the current value of the BPV 228 variable stored in the button value counter 142.

Because the BPT can evolve during a character selection cycle, the number of math operations that can occur during a selection cycle varies. Each instance that a curve 840 crosses over a threshold 830, 832, a new math operation 844 associated with the newly entered region 838 becomes applied to the current value for BPV 228.

The particular path that a curve follows determines which, and how many, of the one or more math operations 844 the processer 108 applies to the BPV. The number of math operations is from one (BPT=SHORT, so BPV=x) to three (for example, BPT=SWIPE via LONG, so BPV=x+1+1 or BPV=x+1−2), where x=the assigned value of the pressed selection button.

Note that the calculated BPV 228 for curves that terminate in a region where the swipe distance is less than the swipe threshold 832 depends on the time elapsed (BPV=x or BPV=x+1). Note that the calculated BPV 228 for curves that terminate in a region where the swipe distance is greater than the swipe threshold 832 do not depend on the time elapsed, for a given direction. In the case of a positive swipe, BPV=x+2 or BPV=x+1+1. In the case of a negative swipe, BPV=x−1 or BPV=x+1−2. In either of these cases, the result is mathematically the same. This consequence is an intentional, so that button activations that are not of the SWIPE BPT can be time-dependent, while button activations that are the SWIPE BPT are time-independent.

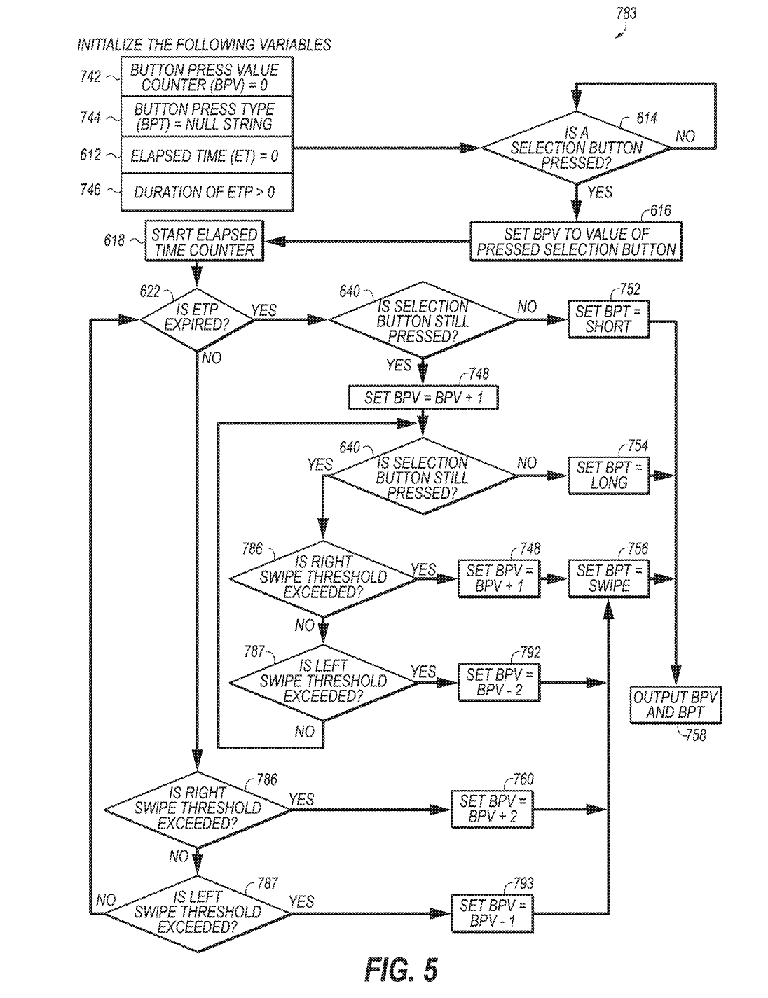

FIG. 5 shows a flowchart of an embodiment of a method 783 for the processor 108 of an electronic device to interpret button presses and swipes. In one step 742 of the method 783, the CPU 108 initializes a variable ‘button press value’ (BPV) stored by the button press value counter 142 to zero. In another step 744 the CPU initializes a variable ‘button press type’ (BPT) to a null string. In another step 612 the CPU 108 initializes a variable ‘elapsed time’ (ET) stored by the elapsed time counter 140 to zero. In another step 746 the CPU initializes a variable ‘duration of the ETP’ to a non-zero value or alternatively receives a non-zero value selected by a user.

In another step 614, the CPU 108 monitors the selection buttons 110 for a pressed selection button 110. Once a first selection button press occurs, in another step 616, the CPU 108 sets the variable BPV to a value equal to the assigned value 222 of the first pressed selection button 110. In another step 618, the CPU 108 starts the elapsed time counter 140.

In a trio of steps 622, 786, 787 the swipe gesture interpreter 144 monitors the selection button pressed in the step 614 for the occurrence of a swipe gesture. At the same time, the elapsed time counter 140 compares the elapsed time (ET) with the selected duration of the elapsed time period (ETP). The step 622 corresponds with the comparison of the curve 840 with the threshold value 830 of FIG. 4.

If in the step 786 the swipe gesture interpreter 144 recognizes that the right (or second) swipe threshold is exceeded before the elapsed time period expires, in a subsequent step 760, the CPU adds two to the variable BPV. If in the step 787 the swipe gesture interpreter 144 recognizes that the left (or first) swipe threshold is exceeded before the elapsed time period expires, in a subsequent step 793, the CPU subtracts one from the variable BPV. The steps 786 and 787 correspond with the comparison of the curve 840 with the threshold value 832 of FIG. 4.

In a subsequent step 756, the CPU updates the variable BPT to SWIPE and in another subsequent step 758 the CPU outputs the current values for the variables BPV and BPT.

If, on the other hand, the elapsed time exceeds the duration of the elapsed time period (i.e. expires) before a swipe gesture occurs, in a subsequent step 640 the CPU 108 determines if the first button press is still pressed.

If the first button press is not still pressed, then in a subsequent step 752 the CPU updates the variable BPT to SHORT and in another subsequent step 758 the CPU outputs the current values for the variables BPV and BPT.

If, however, the first button press is still pressed when the elapsed time period expires, then in an alternate subsequent step 748 the CPU adds one to the variable BPV.

Then, in a trio of steps 640, 786, 787 the CPU 108 monitors the selection buttons 110 to determine if the pressed selection button remains pressed and for the occurrence of a SWIPE BPT.

If the pressed selection button is released without a swipe BPT occurring, then in a subsequent step 754 the CPU updates the variable BPT to LONG and in another subsequent step 758 the CPU outputs the current values for the variables BPV and BPT.

Alternatively, in the step 786, if the swipe gesture interpreter 144 recognizes that the right swipe threshold is exceeded, then in the subsequent step 748 the CPU adds one to the variable BPV. Alternatively, in the step 787, if the swipe gesture interpreter 144 recognizes that the left swipe threshold is exceeded, then in a subsequent step 792 the CPU subtracts two from the variable BPV.

Then in a subsequent step 756, the CPU updates the variable BPT to SWIPE and in another subsequent step 758 the CPU outputs the current values for the variables BPV and BPT.

In one embodiment of the method 783, the CPU 108 interprets as input the character 200 of the menu 240 whose position 242 equals the BPV output in the step 758.

According to a further embodiment of the invention, the CPU executes the method 783 iteratively, selecting one character from the menu with each iteration. According to another embodiment, in a further step the CPU 108 displays the identified character 200 on the screen 104.

Although the method 783 of FIG. 5 is one embodiment of a method for specifying series of characters, the scope of the method is not limited by this particular embodiment, but rather by the scope of the claims.

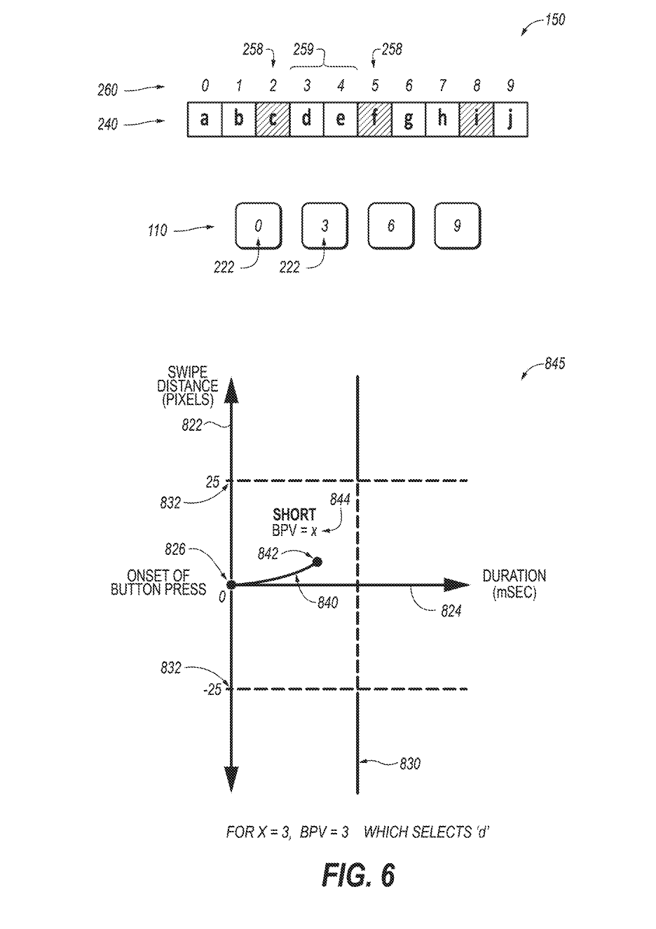

Each of FIGS. 6-9 show an example of the interpretation of button presses and swipes by the method 783 of FIG. 5 according to the interface 150 of FIG. 2, the user gestures of the method 580 of FIG. 3 and the plot 845 of FIG. 4.

The example of FIG. 6 shows the interpretation of button presses and swipes for selection of the character ‘d’.

For the embodiment of the interface 150 of FIG. 2, character ‘d’ occupies position 3 of the character menu 240. Accordingly, in the step 576 of the method 580, the user concludes the character does not correspond with any reference indicator 258. Furthermore, in the step 578 the user concludes that the character occupies the left position of a character pair 259. According to the step 582, the user presses the selection button 110 with the assigned value 222 that corresponds with the character pair 259 containing the desired character. In this case, the user presses the button with assigned value=3, which identifies the character pair 3-4. The user releases the button before a predetermined elapsed time period expires.

The method 783 interprets the input as follows: (1) in the step 616 the CPU records the BPV=3, (2) in the trio of steps 622, 786, 787 the CPU eventually interprets that the ETP is expired but that neither the left or right swipe thresholds are exceeded, and (3) in the step 640 the selection button is no longer pressed. The interpretation is consistent with the curve 840 shown in FIG. 6, which has a terminus 842 in the region 838 of the plot identified by a BPT=SHORT. Furthermore, the region is associated with the math function 844 BPV=x. The CPU substitutes the value of 3 recorded in the step 616 for x, which yields a total BPV=3. According to the menu row 240 and the scale 260, the BPV=3 identifies the character ‘d’.

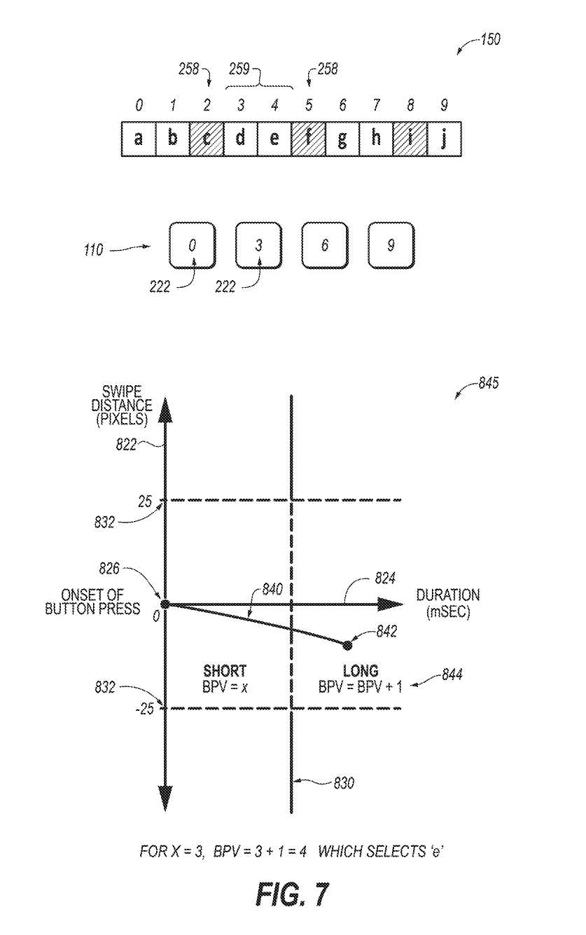

The example of FIG. 7 shows the interpretation of button presses and swipes for selection of the character ‘e’.

For the embodiment of the interface 150 of FIG. 2, character ‘e’ occupies position 4 of the character menu 240. Accordingly, in the step 576 of the method 580, the user concludes the character does not correspond with any reference indicator 258. Furthermore, in the step 578 the user concludes that the character occupies the right position of a character pair 259. According to the step 582, the user presses the selection button 110 with the assigned value 222 that corresponds with the character pair 259 containing the desired character. In this case, the user presses the button with assigned value=3, which identifies the character pair 3-4. The user maintains the button press at least until a predetermined elapsed time period expires.

The method 783 interprets the input as follows: (1) in the step 616 the CPU records the BPV=3, (2) in the trio of steps 622, 786, 787 the CPU eventually interprets that the ETP is expired but that neither the left or right swipe thresholds are exceeded, (3) in the step 640 the selection button is found to be pressed even after the ETP expires, (4) in the step 748 the CPU adds one to the recorded BPV, and (5) in the trio of steps 640, 786, 787 the CPU eventually interprets that the button is no longer pressed but that neither the left or right swipe thresholds are exceeded. The interpretation is consistent with the curve 840 shown in FIG. 7, which has a terminus 842 in the region 838 of the plot identified by a BPT=LONG. Furthermore, the region is associated with the math function 844 BPV=x+1. The CPU substitutes the value of 3 recorded in the step 616 for x, which yields a total BPV=3+1=4. According to the menu row 240 and the scale 260, the BPV=4 identifies the character ‘e’.

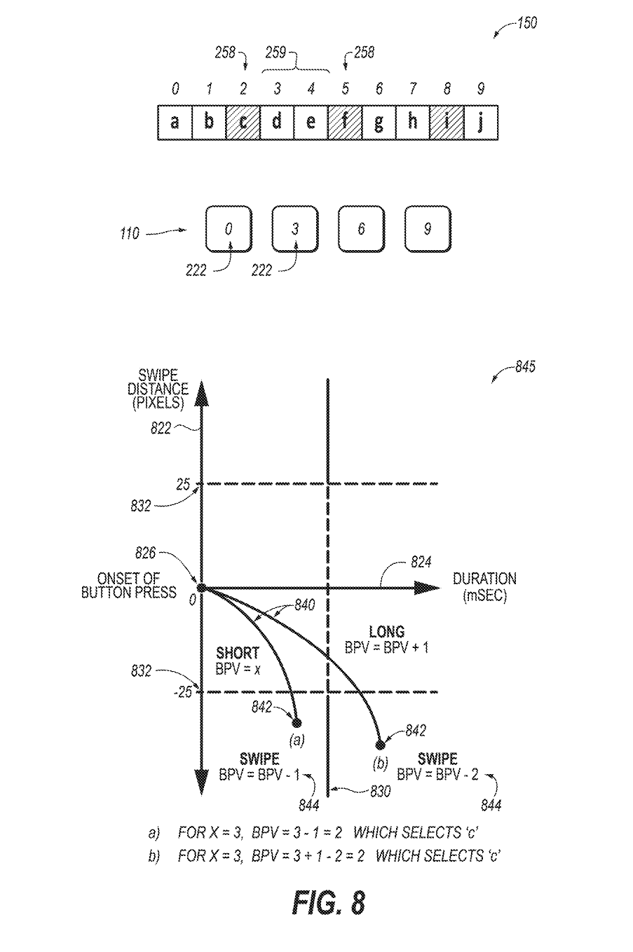

The example of FIG. 8 shows the interpretation of button presses and swipes for selection of the character ‘c’.

For the embodiment of the interface 150 of FIG. 2, character ‘c’ occupies position 2 of the character menu 240. Accordingly, in the step 576 of the method 580, the user concludes the character corresponds with a reference indicator 258. According to the step 586, the user presses the selection button 110 with the assigned value 222 that corresponds with a character pair 259 adjacent the desired character in the menu 240. In this case, the user presses the button with assigned value=3, which identifies the character pair 3-4. Furthermore, during the course of the button press, the user swipes in a direction that corresponds with the position of the character ‘c’ relative to the character pair 259 corresponding to the pressed button.

The method 783 interprets the input as follows: (1) in the step 616 the CPU records the BPV=3, (2) in the trio of steps 622, 786, 787 the CPU interprets that the left swipe threshold is exceeded, and (3) in the step 793 the CPU subtracts one from the recorded BPV. The interpretation is consistent with the curve 840(a) shown in FIG. 8, which has a terminus 842 in the region 838 of the plot identified by a BPT=SWIPE. Furthermore, the region is associated with the math function BPV=x−1. The CPU substitutes the value of 3 recorded in the step 616 for x, which yields a total BPV=3-1=2. According to the menu row 240 and the scale 260, the BPV=2 identifies the character ‘c’.

Alternatively, the method 783 interprets the input as follows: (1) in the step 616 the CPU records the BPV=3, (2) in the trio of steps 622, 786, 787 the CPU eventually interprets that the ETP is expired but that neither the left or right swipe thresholds are exceeded, (3) in the step 640 the selection button is found to be pressed even after the ETP expires, (4) in the step 748 the CPU adds one to the recorded BPV, (5) in the trio of steps 640, 786, 787 the CPU interprets that the left swipe threshold is exceeded and (6) in the step 792 the CPU subtracts two from the recorded BPV. The interpretation is consistent with the curve 840(b) shown in FIG. 8, which has a terminus 842 in the region 838 of the plot identified by a BPT=SWIPE. Furthermore, the region is associated with the math function 844 BPV=x+1−2. The CPU substitutes the value of 3 recorded in the step 616 for x, which yields a total BPV=3+1−2=2. According to the menu row 240 and the scale 260, the BPV=2 identifies the character ‘c’.

The example of FIG. 9 shows the interpretation of button presses and swipes for selection of the character ‘f’.

For the embodiment of the interface 150 of FIG. 2, character ‘f’ occupies position 5 of the character menu 240. Accordingly, in the step 576 of the method 580, the user concludes the character corresponds with a reference indicator 258. According to the step 586, the user presses the selection button 110 with the assigned value 222 that corresponds with a character pair 259 adjacent the desired character in the menu 240. In this case, the user presses the button with assigned value=3, which identifies the character pair 3-4. Furthermore, during the course of the button press, the user swipes in a direction that corresponds with the position of the character ‘f’ relative to the character pair 259 corresponding to the pressed button.

The method 783 interprets the input as follows: (1) in the step 616 the CPU records the BPV=3, (2) in the trio of steps 622, 786, 787 the CPU interprets that the right swipe threshold is exceeded, and (3) in the step 793 the CPU adds two to the recorded BPV. The interpretation is consistent with the curve 840(a) shown in FIG. 9, which has a terminus 842 in the region 838 of the plot identified by a BPT=SWIPE. Furthermore, the region is associated with the math function BPV=x+2. The CPU substitutes the value of 3 recorded in the step 616 for x, which yields a total BPV=3+2=5. According to the menu row 240 and the scale 260, the BPV=5 identifies the character ‘c’.

Alternatively, the method 783 interprets the input as follows: (1) in the step 616 the CPU records the BPV=3, (2) in the trio of steps 622, 786, 787 the CPU eventually interprets that the ETP is expired but that neither the left or right swipe thresholds are exceeded, (3) in the step 640 the selection button is found to be pressed even after the ETP expires, (4) in the step 748 the CPU adds one to the recorded BPV, (5) in the trio of steps 640, 786, 787 the CPU interprets that the right swipe threshold is exceeded, and (6) in the step 748 the CPU adds one to the recorded BPV. The interpretation is consistent with the curve 840(b) shown in FIG. 8, which has a terminus 842 in the region 838 of the plot identified by a BPT=SWIPE. Furthermore, the region is associated with the math function 844 BPV=x+1+1. The CPU substitutes the value of 3 recorded in the step 616 for x, which yields a total BPV=3+1+1=5. According to the menu row 240 and the scale 260, the BPV=5 identifies the character ‘f’.

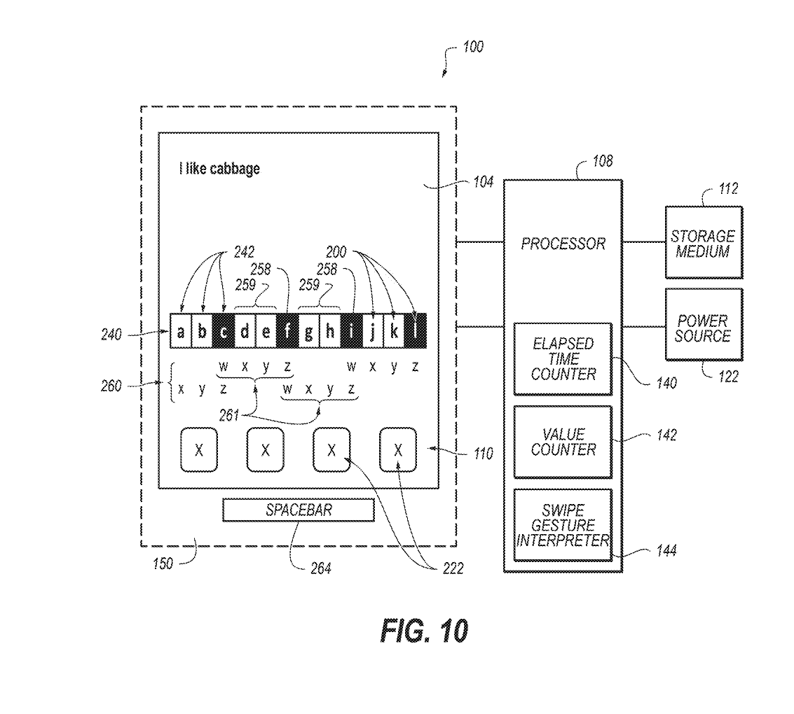

FIG. 10 shows a schematic drawing of another embodiment of the electronic device 100 for input of characters. The device 100 may have some or all the components and functionality described herein with respect to the mobile device 100 of FIG. 1. The device 100 has aspects previously disclosed in FIG. 9 of U.S. Pat. No. 8,487,877, which is hereby incorporated by reference in its entirety.

The electronic device 100 includes the display 104, the plurality of characters 200 that populate positions 242 of the character menu 240, the plurality of selection buttons 110 and the spacebar button 264, which together make up the user interface 150 of the device 100. Each selection button 110 has an assigned button press value 222, identified generically by the variable x. Included as part or within proximity to the menu 240 is the at least one reference indicator 258 and the offset scale 260. The offset scale 260 marks the positions 242 of the menu 240. In one embodiment, values of the offset scale make a repeating pattern, as represented by the variables w, x, y and z. In a further embodiment, some positions 242 of the menu are identified by more than one value of the offset scale 260, for example by the variables w and z.

The display 104, the plurality of selection buttons 110, and the spacebar button 264 are communicatively coupled with the CPU 108, as described in the embodiment of FIG. 1. The CPU 108 includes the elapsed time counter 140, the integer value counter 142 and the swipe gesture interpreter 144, as described in the embodiment of FIG. 1. The CPU 108 is communicatively coupled with the storage medium 112 and the power source 122, as described in the embodiment of FIG. 1.

In the embodiment of FIG. 10, the positions 242 of the menu 240 are arranged in a one-dimensional array similar to the embodiment in FIG. 9 of U.S. Pat. No. 8,487,877, except that the menu 240 and corresponding selection buttons 110 are shown on the display 104 instead of as physical features of the user interface 150. The buttons 110 are communicatively coupled with the CPU 108.

The menu 240 and the offset scale 260 are positioned in respective one-dimensional arrays in the user interface region 150 of the device 100. In one embodiment the character menu 240 and the offset scale 260 are positioned on the user interface 150 so that they lie adjacent to and parallel with one other. In one embodiment, the character menu 240 and the offset scale 260 are programmed in software so that they appear as features on the display 104 of the device 100.

In one embodiment, positions 242 of the menu 240 are distributed in a one-dimensional array in evenly spaced increments. In a further embodiment, values of the offset scale 260 are distributed in a one-dimensional array in spatial increments that match the increment of the menu 240, so that the values of the offset scale identify positions of the menu by their spatial correspondence.

In another embodiment, the menu includes multiple reference indicators 258. In a further embodiment, the reference indicators 258 are distributed along the menu in a repeating pattern, i.e. the indicators occur at regular intervals in the menu 240.

In yet another embodiment, the offset scale is composed of sets 261 of repeating values. For example, in the embodiment of FIG. 10, the offset scale 260 is composed of repeating four value sets, where each set is represented by the values w, x, y and z. In still a further embodiment, the sets 261 of values overlap one another, so that some positions of the menu are identified by more than one offset value. In yet another embodiment, the frequency of the pattern in the offset scale 260 matches the frequency of the pattern of the reference indicators 258 in the menu 240. In still a further embodiment, the positions of the menu that correspond with a reference indicator 259 are also those positions that correspond to more than one value of the offset scale 260. For example, in the embodiment of FIG. 10, each menu position that corresponds with a reference indicator 258 is identified by the values w and z in the offset scale.

In one specific embodiment, the multiple reference indicators 258 occur at every third position 242 of the menu 240. In such an embodiment, the reference indicators 258 demarcate character pairs 259, i.e. the characters that occupy the two menu positions between each indicator. Said another way, the character pairs 259 of the menu 240 are made apparent by the position of the reference indicators 258. In yet a further embodiment the reference indicators 258 correspond with the menu positions identified by the offset values w and z. In a further embodiment, the menu positions of each character pair are identified by the offset values x and y.

The plurality of selection buttons 110 lie on the display 104 of the user interface 150 of the device 100. In one embodiment, the buttons 110 are arranged in a row that corresponds to the physical alignment of the menu 240 on the user interface. Each button is communicatively coupled with the CPU 108 and is assigned a button press value 222 that corresponds with a position of the character menu 240.

In a further embodiment, each button corresponds to an equivalent position in the repeating pattern of the menu. In other words, the value assigned to each button is the same, but corresponds to a unique instance of that value in the repeating values of the offset scale. For example, in the embodiment of FIG. 10, the left-most button corresponds the menu position occupied by ‘a’, the next button to the right corresponds with the menu position occupied by ‘d’, the next button to the right corresponds with the menu position occupied by ‘g’ and the right-most button corresponds with the menu position occupied by ‘j’.

In one embodiment, the value assigned to each button is represented by the variable x. In yet a further embodiment, the variable x corresponds to an equivalent position in the character pair across all the character pairs of the menu. In another embodiment, each button corresponds with a unique character pair 259 of the menu 240.

Each button 110 has the function that when the button is pressed the value 222 assigned to the button is input to the CPU 108 and stored there. Furthermore, each button 110 also has the function that when pressed longer than some pre-selected time duration, the assigned value 222 stored by the CPU 108 at the onset of the button press becomes updated. In one embodiment the update occurs by substituting the stored value with a value that identifies another position of the menu, for example y for x. Furthermore, each button 110 also has the function that when a swipe gesture occurs during the course of the press, the assigned value 222 stored by the CPU 108 at the onset of the button press becomes updated. In one embodiment the update occurs by substituting the stored value with a value that identifies another position of the menu, for example z for x.

In one embodiment, the values of the offset scale (w, x, y and z) are 0, 1, 2 and 3. In a further embodiment, the value 222 assigned to the selection buttons (x) is 1. In still a further embodiment, the menu position identified as x in each set 261 corresponds with the left character in each character pair 259. In a further embodiment, the menu positions 242 are populated by 12 of the 26 characters 200 of the English alphabet. The spacebar 264 also lies in the user interface region 150 of the device 100, can be either a hard or soft key, and is communicatively coupled with the CPU 108.

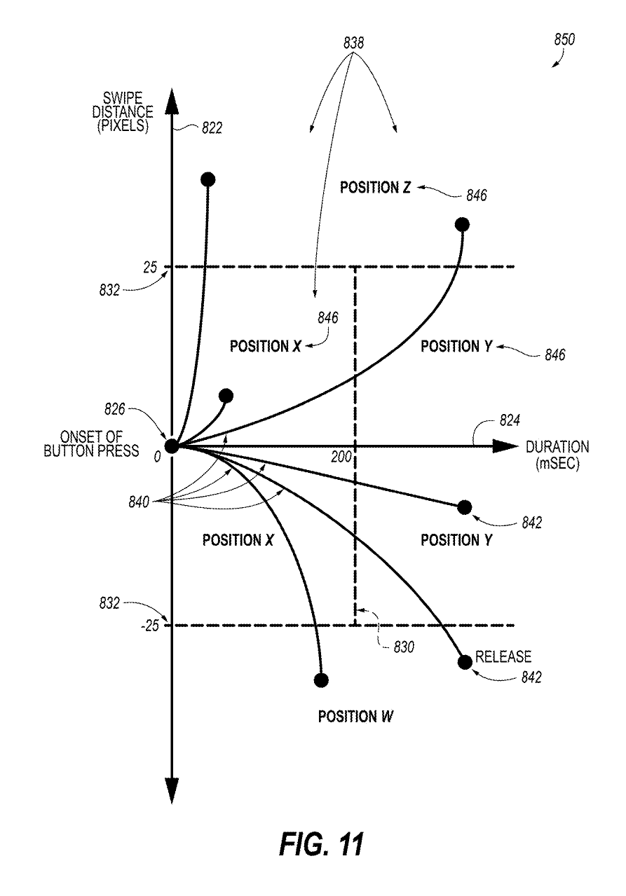

FIG. 11 shows a plot 850 that represents examples of responses for duration and swipe distance for the input gestures ‘button press’ and ‘swipe gesture’, respectively. Each curve 840 represents a possible combination of the responses for duration and swipe distance over the course of a character selection cycle (also referred to as ‘button activation’ in some cases).

In the plot, button press duration is plotted on the x-axis 824 and swipe distance on the y-axis 822. Duration is measured in units of milliseconds and swipe distance is measured in units of pixels. The value for swipe distance can be positive or negative and corresponds with the direction of the swipe along the menu row 240. In one embodiment, a right swipe is a positive displacement and a left swipe is a negative displacement. Onset of a button press occurs at the plot's origin 826 and marks the point in time and distance where the onset of an input gesture occurs. The release of a button is represented by a terminus 842 at the end of each curve. The path that a curve 840 follows through the plot reflects the duration and swipe distance of a received button activation.

The response of any input gesture is converted to a binary value by comparing the current terminus of the response with threshold values for duration and swipe distance. The threshold value enables the analog output of each measured response to be recast as a binary output, i.e. a high or low value. A terminus that exceeds a threshold value is a high value; one that falls below the threshold value is a low value. Threshold values are selectable and can be changed.

In the plot 845, the duration axis 824 is divided into two segments by an elapsed time threshold 830, which in this example equals 200 msec. The elapsed time threshold corresponds with the end of a selectable elapsed time period (ETP) mentioned elsewhere throughout this disclosure.

The swipe distance axis 822 is divided into three segments by a swipe distance threshold 832, which in this example equals −25 and +25 pixels. The swipe distance threshold identifies the minimum required positional displacement (positive or negative) for a swipe gesture to be classified as a SWIPE BPT (rather than a LONG or SHORT BPT). The polarity of the swipe distance value indicates the direction of the displacement.

Applying the threshold values 830, 832 to the plot 845 divides the plot into four regions 838. Each region represents a unique combination of the binary output values from the input gestures. In other words, for the gesture responses ‘button press duration’ and ‘swipe distance’ each region represents one possible combination of high and low values (duration:swipe distance) as follows—low:low, high:low, any:negative-high, any:positive-high. For the example of FIG. 11, the measured responses are distributed among the four regions as follows: <200:−25<d<25, >200:−25<d<25, any:d<−25, any:d>25, where d is the length and direction of the swipe.

Each region 838 of the plot corresponds with a value of the offset scale 260 (w, x, y or z), and thereby a position 242 of the menu 240. During the course of a character selection cycle, the position of the curve 840 in the plot 850 reflects the current measured responses for duration and swipe distance. Because the path that a curve 840 takes through the plot may intersect more than one region 838 of the plot during the course of a selection cycle, the offset value (w, x, y or z) identified by the input gesture may evolve. Each instance that a curve 840 crosses over a threshold 830, 832, the identified offset value changes and, in one embodiment, becomes updated in the CPU.

The final offset value identified by a character selection cycle is determined when the button press is lifted, which is identified by the terminus 842 of the curve. For the embodiment of FIG. 11, the possible values are w, x, y and z, which in one embodiment represent the values 0, 1, 2 and 3 respectively.

Note that curves that terminate in a region where the swipe distance is less than the swipe threshold 832 are time dependent. Note that curves that terminate in a region where the swipe distance is greater than the swipe threshold 832 do not depend on the time elapsed, for a given direction. This consequence is intentional, so that button activations that do not incorporate a swipe gesture can be time-dependent, while button activations that incorporate a swipe gesture are time-independent.

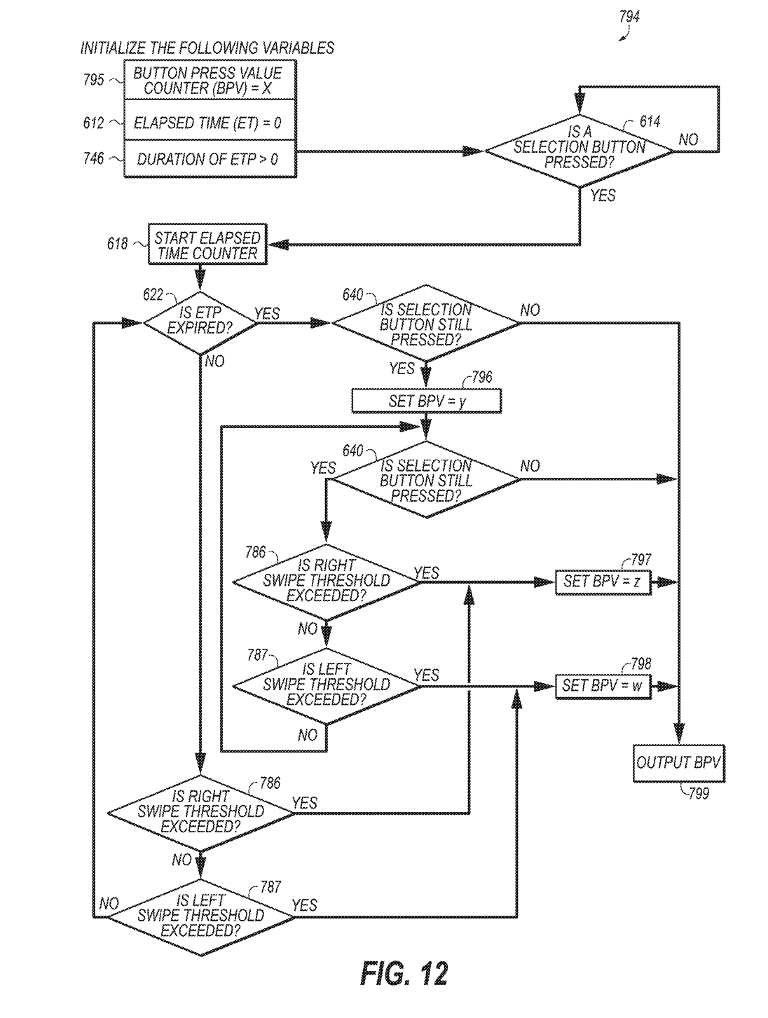

FIG. 12 shows a flowchart of an embodiment of a method 794 for the processor 108 of an electronic device to interpret button presses and swipes. In one step 795 of the method 794, the CPU 108 initializes a variable ‘button press value’ (BPV) stored by the button press value counter 142 to x. In another step 612 the CPU 108 initializes a variable ‘elapsed time’ (ET) stored by the elapsed time counter 140 to zero. In another step 746 the CPU initializes a variable ‘duration of the ETP’ to a non-zero value or alternatively receives a non-zero value selected by a user.

In another step 614, the CPU 108 monitors the selection buttons 110 for a pressed selection button 110. Once a selection button press occurs, in another step 618, the CPU 108 starts the elapsed time counter 140.

In a trio of steps 622, 786, 787 the swipe gesture interpreter 144 monitors the selection button pressed in the step 614 for the occurrence of a swipe gesture. At the same time, the elapsed time counter 140 compares the elapsed time (ET) with the selected duration of the elapsed time period (ETP). The step 622 corresponds with the comparison of the curve 840 with the threshold value 830 of FIG. 11.

If in the step 786 the swipe gesture interpreter 144 recognizes that the right (or second) swipe threshold is exceeded before the elapsed time period expires, in a subsequent step 797, the CPU updates the variable BPV from x to z. If in the step 787 the swipe gesture interpreter 144 recognizes that the left (or first) swipe threshold is exceeded before the elapsed time period expires, in a subsequent step 798, the CPU updates the variable BPV from x to w. The steps 786 and 787 correspond with the comparison of the curve 840 with the threshold values 832 of FIG. 11.

In a subsequent step 799 the CPU outputs the value currently stored in the variable BPV.

If, on the other hand, the elapsed time exceeds the duration of the elapsed time period (i.e. expires) before a swipe gesture occurs, then in a subsequent step 640 the CPU 108 determines if the button is still pressed.

If the button is not still pressed, then in the subsequent step 799 the CPU outputs the value currently stored in the variable BPV.

If, however, the first button press is still pressed when the elapsed time period expires, then in an alternate subsequent step 796 the CPU updates the variable BPV from x toy.

Then, in a trio of steps 640, 786, 787 the CPU 108 monitors the selection buttons 110 to determine if the pressed selection button remains pressed and for the occurrence of a swipe gesture.

If the pressed selection button is released without a swipe gesture occurring, then in a subsequent step 799 the CPU outputs the value currently stored in the variable BPV.

Alternatively, in the step 786, if the swipe gesture interpreter 144 recognizes that the right swipe (or second) threshold is exceeded, then in the subsequent step 797 the CPU updates the variable BPV from y to z. Alternatively, in the step 787, if the swipe gesture interpreter 144 recognizes that the left (or first) swipe threshold is exceeded, then in the subsequent step 798 the CPU updates the variable BPV from y to w. In a subsequent step 799 the CPU outputs the value currently stored in the variable BPV.

In one embodiment of the method 794, the CPU 108 interprets as input the character 200 of the menu 240 whose position 242 corresponds to the selection button pressed and to the value (represented by w, x, y or z) output in the step 799. In a further embodiment, the CPU outputs to the display 104 the character 200 that interpreted as input by the user.

According to a further embodiment of the invention, the CPU executes the method 794 iteratively, which selects one character from the menu for each iteration of the loop. According to another embodiment, in a further step the CPU 108 displays the identified character 200 on the screen 104.

Although the method 783 of FIG. 12 is one embodiment of a method for specifying series of characters, the scope of the method is not limited by this particular embodiment, but rather by the scope of the claims.

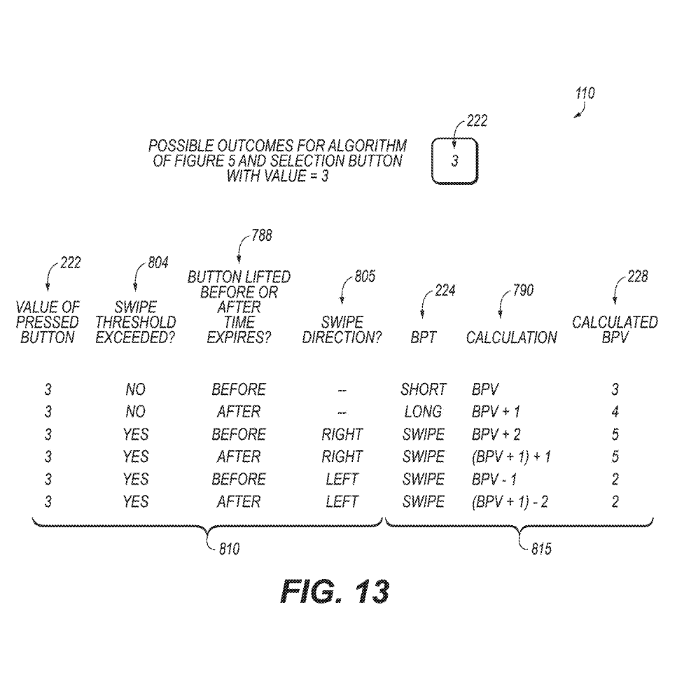

FIG. 13 shows a button 110 of the user interface 150 of FIG. 2 and a table. The selection button 110 has an assigned button press value 222 equal 3. The table shows possible values for seven variables 222, 804, 788, 224, 805, 790, 228 of the method 783 of FIG. 5. Four of the variables are input variables 810, which are selectable by a user. Three of the variables are output variables 815, which are determined by the device 110 according to the logic of FIG. 5.

The input variables 810 selectable by a user are: the variable ‘value of pressed button’ 222, a variable ‘swipe threshold exceeded?’ 804, a variable ‘button lifted before or after time expires?’ 788 and a variable ‘swipe direction’ 805. The output variables 815 determined by the device are: the variable ‘button press type (BPT)’ 224, the calculation 790, and the ‘calculated button press value (BPV)’ 228.

Each row of the table discloses a unique combination of the four input variables 810. For the embodiment shown, the ‘button press value’ 222 is constant. With the remaining three input variables ‘swipe threshold exceeded?’ 804, ‘button lifted?’ 788 and ‘swipe direction’ 805 there are six possible unique combinations: no/before/any, no/after/any, yes/before/right, yes/after/right, yes/before/left, and yes/after/left. Each combination specifies a unique calculation 790. The specified calculation 790, together with the value of the pressed button 222, determines a value for the variable ‘calculated BPV’ 228.

A notable outcome of the logic of the method 783 is that for a given assigned button press value 222, whether the swipe gesture exceeds the swipe threshold before or after the ETP expires, the same calculated BPV 228 results. For example, a swipe that exceeds the swipe threshold before the ETP expires yields a calculated BPV equal four, i.e. 3+2=5. And a swipe that exceeds the swipe threshold after the ETP expires also yields a calculated BPV equal four, i.e. (3+1)+1=5. The effect is that for the method 783 of FIG. 5, button activations that are SWIPE BPT are time-independent.

Another notable outcome is the fact that although button activations that are SWIPE BPT are time independent, button activations that are not SWIPE BPT (i.e. SHORT and LONG BPTs) are not. For button activations that are not SWIPE BPT, the duration of the button press still determines whether the calculated BPV 228 equals the value of the pressed button 222 (SHORT BPT, in this embodiment=3) or one more than the value of the pressed button (LONG BPT, in this embodiment=3+1=4).

The assigned button values 222 and values for the input and output variables 810, 815 are merely examples used to demonstrate the embodiments of FIGS. 2, 3, 4 and 5. The scope of the invention is not limited by the variables and values shown here, but rather by the scope of the claims.

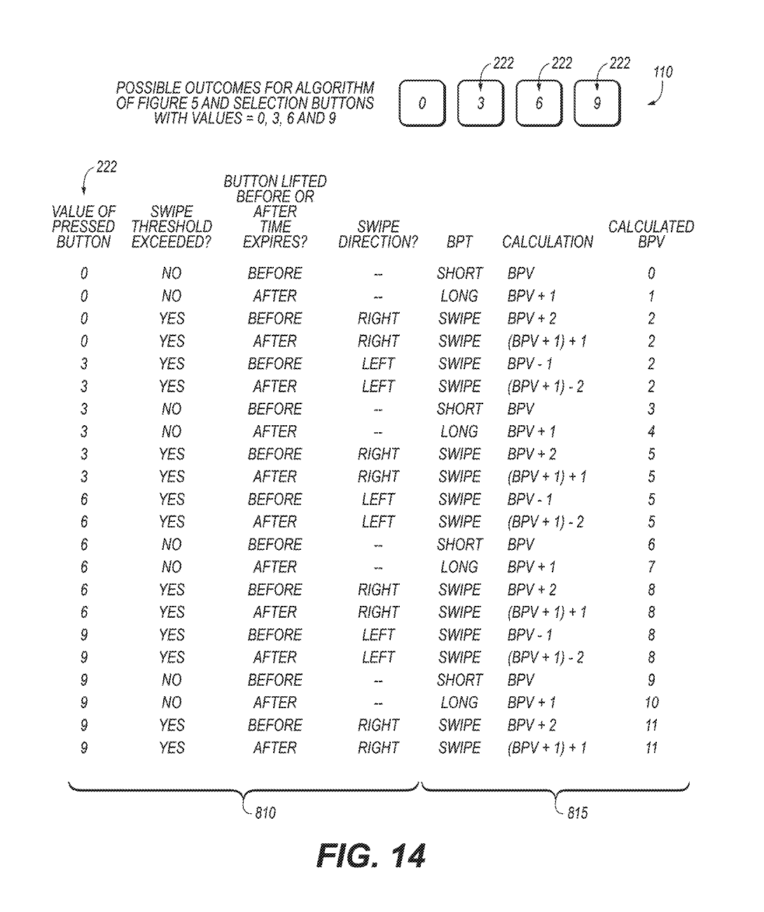

FIG. 14 shows a portion of an alternative embodiment of the user interface 150 of FIG. 2 and a corresponding table of variables 810, 815. The portion of the alternative embodiment includes the selection buttons 110 and assigned button press values 222 of the embodiment of FIG. 2. The table reinforces that for a given assigned button press value 222, whether the swipe gesture exceeds a threshold value before or after the ETP expires, the same calculated BPV 228 results. For example, for the assigned button press value equal 6, a swipe threshold value exceeded before the ETP expires yields a calculated BPV equal seven, i.e. 6+2=8. And a swipe threshold value exceeded after the ETP expires also yields a calculated BPV equal seven, i.e. (6+1)+1=8. The effect is that for the method 783 of FIG. 5, button activations that are SWIPE BPT are time-independent. Furthermore, with four selection buttons 110 and the assigned values 222 equal 0, 3, 6 and 9 any value from 0 to 11 can be produced. Of further note is that with the appropriate selection of the button press values 222, values selected with a swipe gesture can be identified by a swipe gesture from either direction (left or right). For example, in the embodiment of FIG. 14, a calculated BPV=5 can be produced with a right swipe gesture using button press value=3 (see lines 9 or 10) or a left swipe gesture using button press value=6 (see lines 11 or 12). Therefore, in this embodiment, a character assigned to the menu position=5 is selectable with either a right or left swipe gesture.

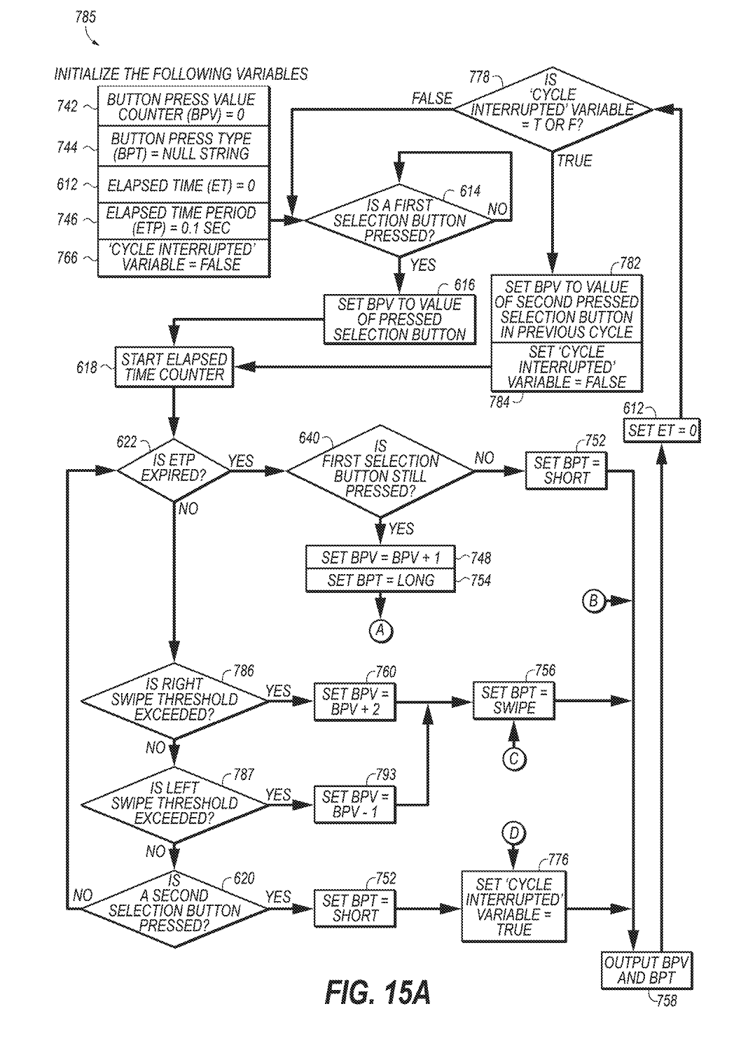

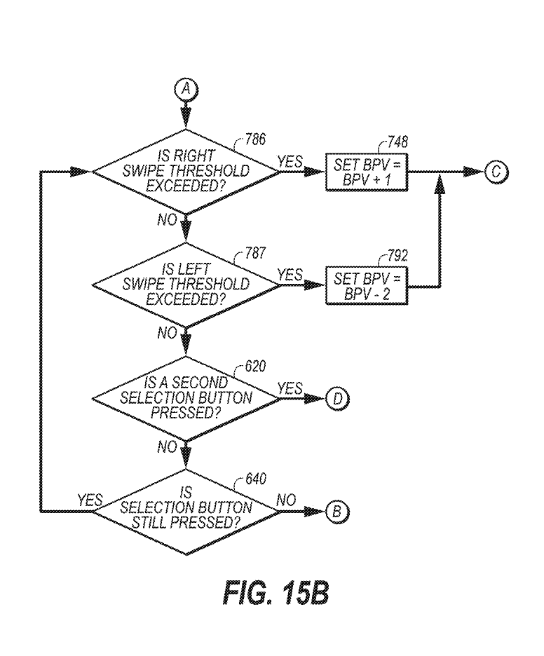

FIGS. 15A and 15B show a flowchart of an embodiment of a method 785 for the processor 108 of an electronic device to interpret button presses and swipes. In one step 742 of the method 783, the CPU 108 initializes a variable ‘button press value’ (BPV) stored by the button press value counter 142 to zero. In another step 744 the CPU initializes a variable ‘button press type’ (BPT) to a null string. In another step 612 the CPU 108 initializes a variable ‘elapsed time’ (ET) stored by the elapsed time counter 140 to zero. In another step 746 the CPU initializes a variable ‘duration of the ETP’ to a non-zero value or alternatively receives a non-zero value selected by a user. In another step 766 the CPU initializes a variable ‘cycle interrupted’ to FALSE.

In another step 614, the CPU 108 monitors the selection buttons 110 for a pressed selection button 110. Once a first selection button press occurs, in another step 616, the CPU 108 sets the variable BPV to a value equal to the assigned value 222 of the first pressed selection button 110. In another step 618, the CPU 108 starts the elapsed time counter 140.

In a quartet of steps 622, 786, 787, 620 the swipe gesture interpreter 144 monitors the selection button pressed in the step 614 for the occurrence of a swipe gesture, the elapsed time counter 140 compares the elapsed time (ET) with the selected duration of the elapsed time period (ETP), and the CPU 108 monitors the selection buttons 110 for another button press. The step 622 corresponds with the comparison of the curve 840 with the threshold value 830 of FIG. 4. The steps 786 and 787 correspond with the comparison of the curve 840 with the threshold value 832 of FIG. 4.

If in the step 786 the swipe gesture interpreter 144 recognizes that the right (or second) swipe threshold is exceeded before (a) the elapsed time period expires or (b) a second button press occurs, then in a subsequent step 760, the CPU adds two to the variable BPV. If in the step 787 the swipe gesture interpreter 144 recognizes that the left (or first) swipe threshold is exceeded before (a) the elapsed time period expires or (b) a second button press occurs, then in a subsequent step 793, the CPU subtracts one from the variable BPV.

In a subsequent step 756, the CPU updates the variable BPT to SWIPE and in another subsequent step 758 the CPU outputs the current values for the variables BPV and BPT.

If, on the other hand, in the step 622 the elapsed time exceeds the duration of the elapsed time period (i.e. expires) before (a) a swipe gesture occurs or (b) a second button press occurs, then in a subsequent step 640 the CPU 108 determines if the first button press is still pressed.

If the first button press is not still pressed, then in a subsequent step 752 the CPU updates the variable BPT to SHORT and in another subsequent step 758 the CPU outputs the current values for the variables BPV and BPT.

If, however, the first button press is still pressed when the elapsed time period expires, then in an alternate subsequent step 748 the CPU adds one to the variable BPV, then in a subsequent step 754 the CPU updates the variable BPT to LONG.

Then, in a quartet of steps 786, 787, 620, 640 in FIG. 15B, the swipe gesture interpreter 144 continues to monitor the selection button pressed in the step 614 for the occurrence of a swipe gesture, the CPU 108 continues to monitor the selection buttons 110 for the occurrence of an additional button press, and the CPU continues to monitor the selection buttons to determine if the pressed selection button remains pressed.

If in the step 786 of FIG. 15B the swipe gesture interpreter 144 recognizes that the right (or second) swipe threshold is exceeded before a second button press occurs, then in the subsequent step 748, the CPU adds one to the variable BPV. Alternatively, if in the step 787 of FIG. 15B the swipe gesture interpreter 144 recognizes that the left (or first) swipe threshold is exceeded before a second button press occurs, then in a subsequent step 792, the CPU subtracts two from the variable BPV. The steps 786 and 787 correspond with the comparison of the curve 840 with the threshold value 832 of FIG. 4.

Then, in the subsequent step 756 of FIG. 15A, the CPU updates the variable BPT to SWIPE and in another subsequent step 758 the CPU outputs the current values for the variables BPV and BPT.

Alternatively, if in the step 640 of FIG. 15B the CPU interprets that the pressed selection button is released without a swipe gesture or a second button press occurring, then in the subsequent step 758 in FIG. 15A the CPU outputs the current values for the variables BPV and BPT.

Alternatively, if in the step 620 of FIG. 15B the CPU interprets a second button press while the first button press of the step 614 is still pressed, then in a subsequent step 776 the CPU changes the variable ‘cycle interrupted’ from FALSE to TRUE, and in another subsequent step 758 the CPU outputs the current values for the variables BPV and BPT.

If, on the other hand, in the step 620 of FIG. 15A the CPU interprets a second button press before (a) the swipe distance threshold is exceeded, (b) the elapsed time period expires, or (c) the first button press is lifted, then in the subsequent step 752 the CPU updates the variable BPT to SHORT, in the subsequent step 776 the CPU changes the variable ‘cycle interrupted’ from FALSE to TRUE, and in another subsequent step 758 the CPU outputs the current values for the variables BPV and BPT.

In a step 612 subsequent to the step 758 that outputs values for the variables BPV and BPT, the CPU resets the variable ‘elapsed time’ (ET) stored by the elapsed time counter 140 to zero. Then, in a subsequent step 778, the CPU determines the value stored in the variable ‘cycle interrupted’.

If the CPU determines that the variable ‘cycle interrupted’ is FALSE, then in a subsequent step 614 the CPU 108 monitors the selection buttons 110 for a next pressed selection button. Alternatively, if the CPU determines the variable ‘cycle interrupted’ is TRUE, in a subsequent step 782 the CPU sets the variable BPV stored by the button press value counter 128 to the button press value 222 of the second pressed selection button in the previous character selection cycle. Then, in a subsequent step, the CPU updates the variable ‘cycle interrupted’ to FALSE.

In one embodiment of the method 785, the CPU 108 interprets as input the character 200 of the menu 240 whose position 242 equals the BPV output in the step 758.

According to a further embodiment of the invention, the CPU executes the method 785 iteratively, selecting one character from the menu with each iteration. According to another embodiment, in a further step the CPU 108 displays the identified character 200 on the screen 104.

Although the method 785 of FIGS. 15A and 15B is one embodiment of a method for specifying series of characters, the scope of the method is not limited by this particular embodiment, but rather by the scope of the claims.

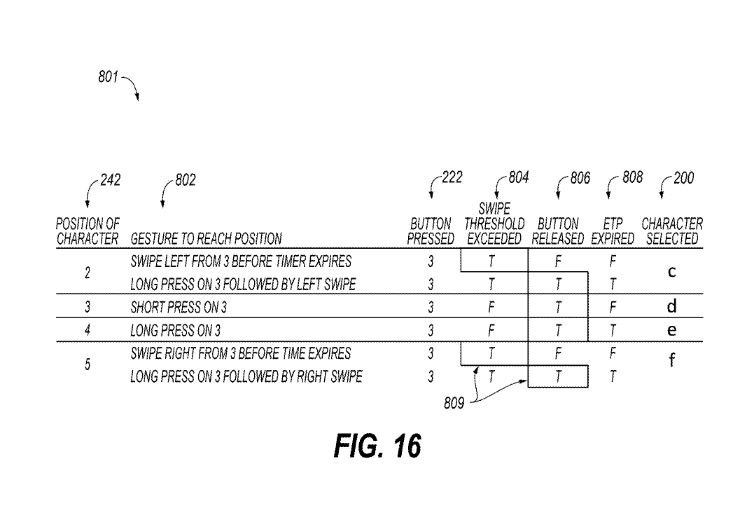

FIG. 16 shows a table 801 that lists the menu positions 242 that can be identified using a single button from the user interface 150 of FIG. 2 and the method of FIG. 5. FIG. 16 shows an embodiment where the button press value 222 equals 3 and the menu positions 242 that can be identified are 2, 3, 4 and 5, but the method of FIG. 5 may clearly be applied to assigned button press values other than 3 to make other menu positions identifiable.

Furthermore, although the table 801 in the embodiment of FIG. 16 shows only four positions, the number of menu positions can be increased by applying the method of FIG. 5 to multiple selection buttons 110 within an interface 150.

The table 801 includes values for the following variables: variable ‘menu position’ 242, variable ‘gesture to select character’ 802, variable ‘assigned value of pressed button’ 222, variable ‘swipe threshold exceeded’ 804, variable ‘button released’ 806, variable ‘ETP expired’ 808 and variable ‘character selected’ 200.

The table 801 shows that for positions accessible using a SWIPE BPT (Positions 2 and 5 in the embodiment of FIG. 16), there is always at least two ways for a user to reach that position. Furthermore, for those positions, the variable ‘ETP expired’ is FALSE for at least one way and TRUE for at least one of the others. That fact guarantees that even if a user fails to exceed the swipe distance when they expect to (i.e. expected to exceed the swipe threshold before ETP expired but completed it after, or vice-versa), the same character gets selected anyway. That fact makes SWIPE BPT time-independent.

Each row of the table has one grey box 809 that marks one or the other of the variables ‘swipe threshold completed’ 804 and ‘button released’ 806. The grey box 809 indicates the action that signifies the end the character selection cycle.

For button activations where a swipe gesture does not exceed the swipe threshold (i.e. SHORT and LONG BPTs), the character selection cycle terminates with a button release. In other words, if a button is released and a swipe threshold is not exceeded, then the selection cycle ends. (In an alternative embodiment, the selection cycle extends until the ETP expires for short presses, but that isn't necessary.)

On the other hand, for button activations where a swipe gesture does exceed the swipe distance threshold (i.e. a SWIPE BPT), the selection cycle may or may not immediately end. In one embodiment, swipes that exceed the swipe threshold before the ETP expires cause the selection cycle to immediately end, but swipes that exceed the swipe threshold after the ETP expires do not cause the selection cycle to end. For swipes that exceed the threshold after the ETP expires, the button release ends the selection cycle. This enables the user to “undo” a SWIPE BPT, if they want, by swiping back to the position where the swipe gesture originated. Ultimately there are multiple ways that the end of a character selection can be triggered that are consistent with gestures 802 of FIG. 16 and the logic of the method 783 of FIG. 5.

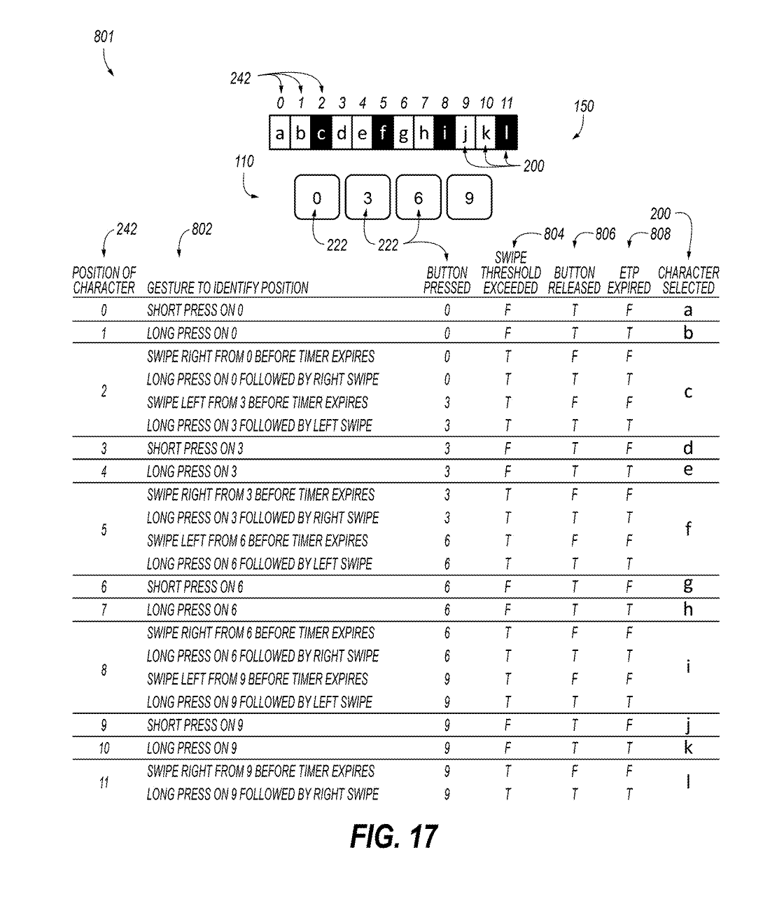

FIG. 17 shows a table 801 that lists the menu positions 242 of the menu 240 can be identified using the selection buttons 110 of the user interface 150 of FIG. 2 and the method of FIG. 5. The table 801 of the embodiment of FIG. 17 also includes assigned characters 200 for each position of the menu 240.

The table includes values for the following variables: variable ‘menu position’ 242, variable ‘gesture to identify position’ 802, variable ‘button pressed’ 222, variable ‘swipe threshold exceeded’ 804, variable ‘button released’ 806, variable ‘ETP expired’ 808 and character 200. The table of FIG. 17 is just one possible embodiment of the user interface of FIG. 2 and the methods of FIGS. 3, 4, 5, 15A and 15B, but in alternative embodiments could include alternative character assignments, alternative assigned values for the selection buttons 110, and alternative numbers of menu positions 242 and selection buttons 110, among other possible variations.

The embodiment of FIG. 17 shows button press values 222 that enable selection of characters using a swipe from either direction (left or right). In the embodiment of FIG. 17, the button press values 222 occur in increments of three (0, 3, 6 and 9). According to the method 783 of FIG. 5, these values lead swipe gestures in opposing directions from adjacent buttons to identify the same menu position 242. For example, a right swipe on the button with value=3 identifies menu position=5. Furthermore, a left swipe on the button with value=6 also identifies the menu position=5. Therefore, according to the user interface 150 of FIG. 2 and the method 783 of FIG. 5, with the appropriate number of buttons and appropriate selection of assigned values for those buttons, a continuous sequence of menu positions are identifiable that include the quality that all menu positions identified with a swipe gesture can be identified with a swipe gesture from either direction.

In a further embodiment, with each additional button added to the plurality of selection buttons 110, an additional three menu positions can be added to the menu 240. The table 801 of FIG. 17 embodies the linking together of the basic unit of character positions 242 selectable with a single selection button that is shown in FIG. 16.

In an alternative embodiment, the button press values 222 occur in increments of 4 (0, 4, 8 . . . ) and swipe gestures from opposite directions identify adjacent menu positions instead of the same position. For example, a right swipe on a button with assigned value=4 identifies the menu position=6. Furthermore, a left swipe on a button with assigned value=8 identifies the menu position=7. The alternative embodiment increases the number of menu positions that are selectable using a given number of selection buttons, but gives up the possibility to select a swipe position from either direction.

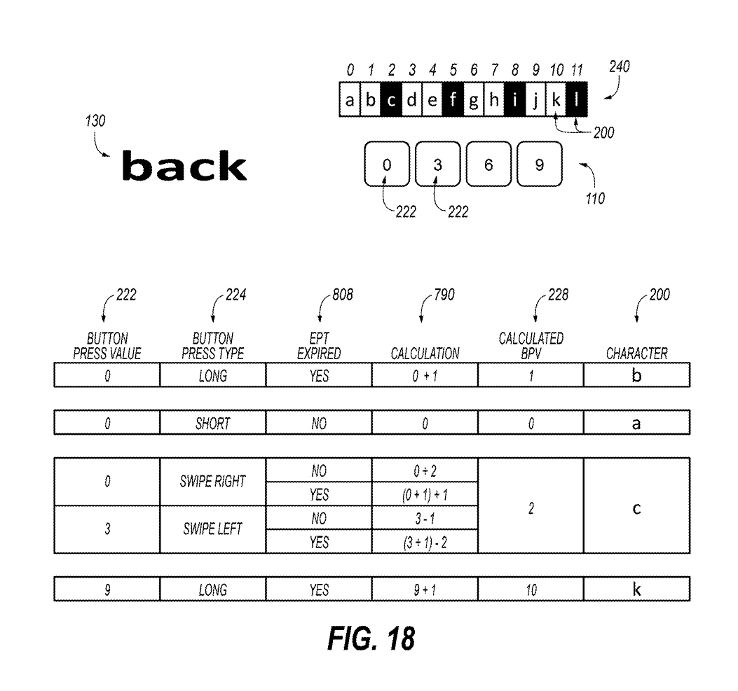

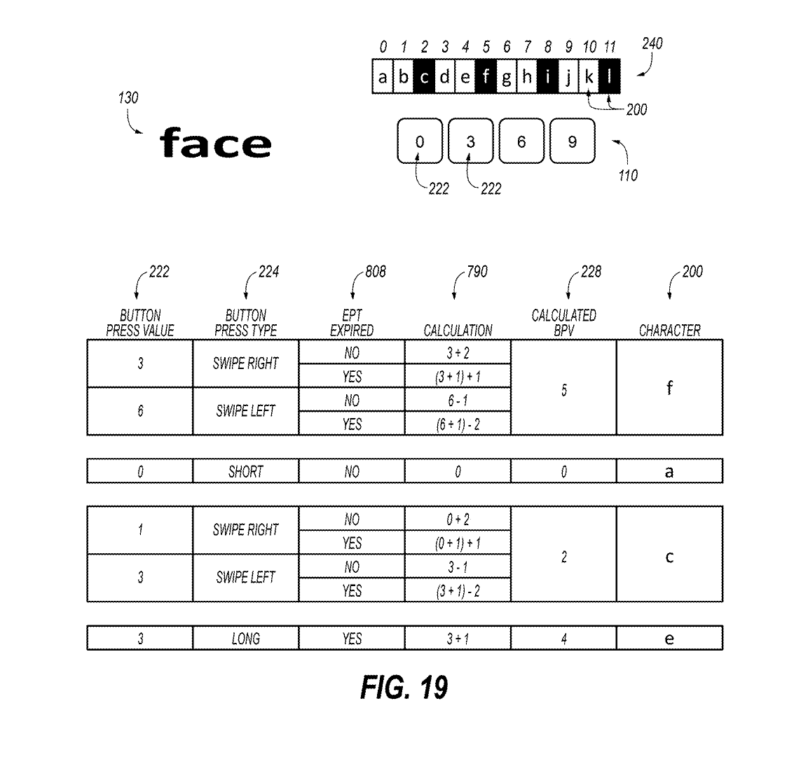

FIGS. 18 and 19 show examples of how a word 130 is composed according to the method 785 of FIGS. 15A and 15B and the embodiment of the user interface 150 of FIG. 2. For the example of FIG. 18, the composed word 130 is ‘back’.

Each row of FIG. 18 shows one or more ways in which a particular character 200 of the word 130 could be composed from a ‘button press value’ 222 and a ‘button press type’ 224.

Values for the variables ‘button press value’ 222 and ‘button press type’ 224 are selected by a user based on the position of an intended character 200 in the menu 240 and knowledge about how gestures identify calculations 790 according to the method 785 of FIGS. 15A and 15B. The variable ‘ETP expired’ 808 shows that for the SWIPE BPT the swipe gesture may be completed before or after the ETP expires and the same character becomes selected in either case.

The variable ‘calculation’ 790 (sometimes referred to as ‘math operation’) is specified based on the BPT 224 according to the logic of the method 785 of FIGS. 15A and 15B. The variable ‘calculated BPV’ 228 (sometimes also referred to as ‘total BPV’) is the result of the calculation of 790 and the assigned BPV 222 selected by the user. The variable ‘calculated BPV’ 228 shows that for a menu position identified by a SWIPE BPT, the swipe gesture may occur from either direction (left or right). The device identifies the user's intended character 200 based on the ‘calculated BPV’ and the assignment of the characters in the menu 240.

For the example of FIG. 18, a button with assigned BPV=0 activated with gestures that correspond to BPT=LONG identifies the character ‘b’. A button with assigned BPV=0 activated with gestures that correspond to BPT=SHORT identifies the character ‘a’. A button with assigned BPV=0 activated with gestures that correspond to BPT=SWIPE RIGHT or a button with assigned BPV=3 activated with gestures that correspond to BPT=SWIPE LEFT identifies the character ‘c’. A button with assigned BPV=9 activated with gestures that correspond to BPT=LONG identifies the character ‘k’.

For the example of FIG. 19, the composed word 130 is ‘face’. Each row of FIG. 19 shows one or more ways in which a character 200 could be composed from a ‘button press value’ 222 and a ‘button press type’ 224.

Values for the variables ‘button press value’ 222 and ‘button press type’ 224 are selected by a user based on the position of an intended character 200 in the menu 240 and knowledge about how gestures identify calculations 790 (sometimes referred to as math operations) according to the method 785 of FIG. 15A or 15B. The variable ‘ETP expired’ 808 shows that for the SWIPE BPT the swipe distance threshold may be completed before or after the ETP expires and the same character becomes selected in either case. The variable ‘calculated BPV’ 228 shows that for a menu position identified by a SWIPE BPT, the swipe gesture may occur from either direction (left or right).

The variable ‘calculation’ 790 is specified based on the BPT 224 according to the logic of the method 785 of FIGS. 15A and 15B. The variable ‘calculated BPV’ 228 is the result of the calculation of 790 and the assigned BPV 222 selected by the user. The device identifies the user's intended character 200 based on the ‘calculated BPV’ and the assignment of the characters in the menu 240.

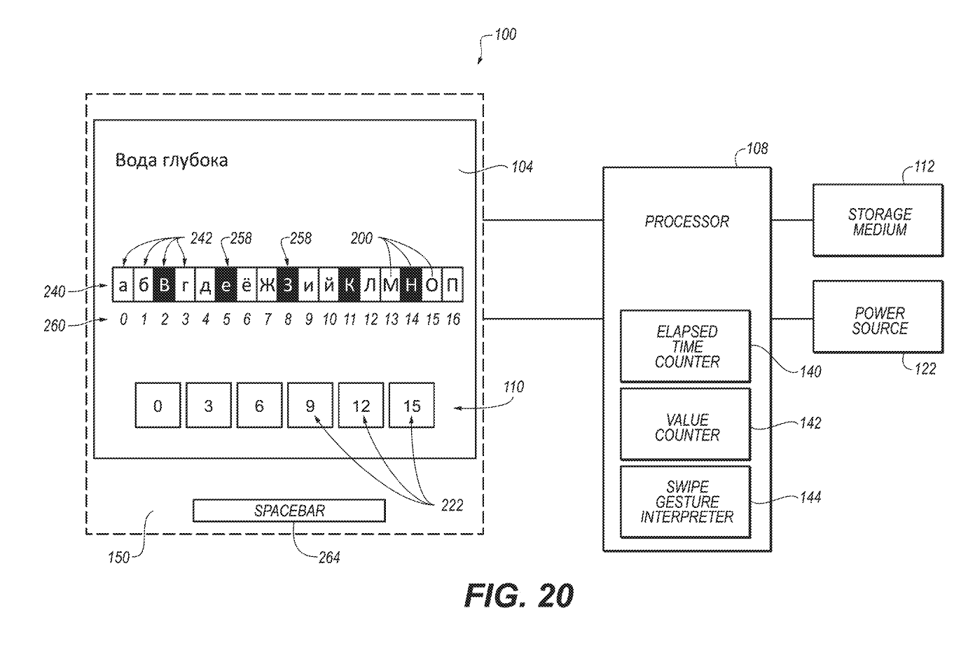

FIG. 20 shows a schematic drawing of another embodiment of the electronic device 100 for input of characters. The device 100 may have some or all the components and functionality described herein with respect to the mobile device 100 of FIG. 1. The device 100 has aspects previously disclosed in FIG. 9 of U.S. Pat. No. 8,487,877, which is hereby incorporated by reference in its entirety.

The electronic device 100 includes the display 104, the plurality of characters 200 that populate positions 242 of the character menu 240, the plurality of selection buttons 110 and the spacebar button 264, which together make up the user interface 150 of the device 100. Each of the plurality of selection buttons 110 has an assigned button press value 222. Included as part or within proximity to the menu 240 is the at least one reference indicator 258 and the offset scale 260. The display 104, the plurality of selection buttons 110, and the spacebar button 264 are communicatively coupled with the CPU 108, as described in the embodiment of FIG. 1. The CPU 108 includes the elapsed time counter 140, the integer value counter 142 and the swipe gesture interpreter 144, as described in the embodiment of FIG. 1. The CPU 108 is communicatively coupled with the storage medium 112 and the power source 122, as described in the embodiment of FIG. 1.

In the embodiment of FIG. 20, the menu 240 has 17 menu positions 242 and the plurality of selection buttons includes six buttons with the assigned button press values 222: ‘0, 3, 6, 9, 12, 15’. In a further embodiment, the menu positions 242 are populated by 17 of the 33 characters 200 of the Russian alphabet.

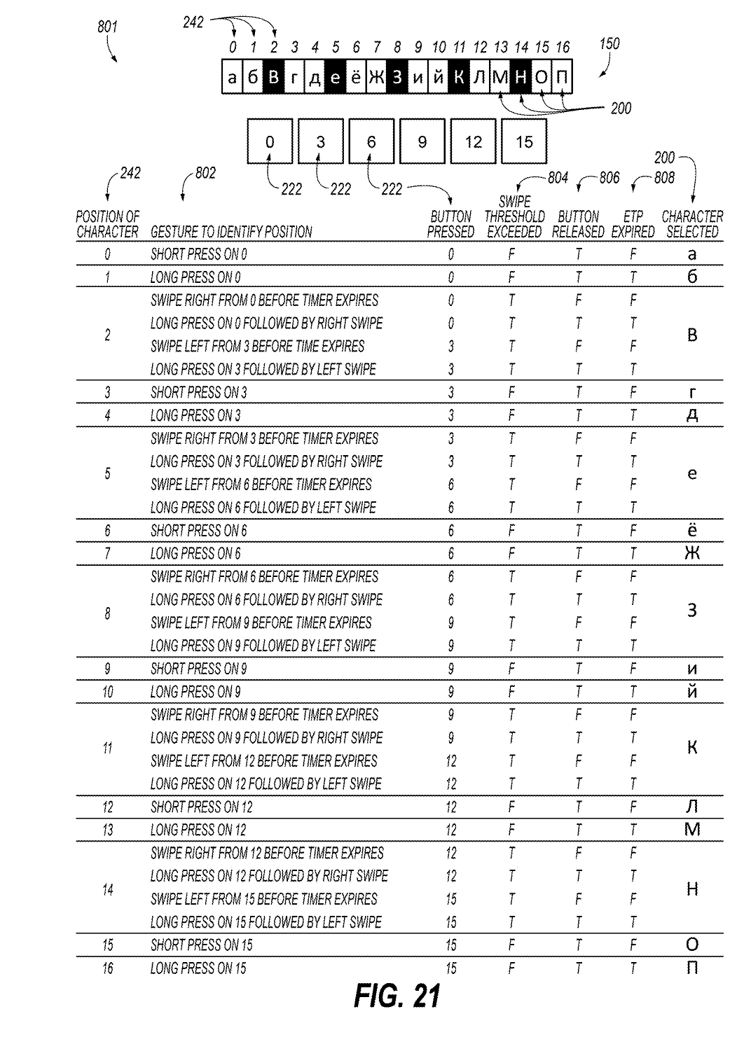

FIG. 21 shows a table 801 that lists the ways each position 242 of the menu 240 can be identified using the logic of the method 785 of FIGS. 15A and 15B for the embodiment of the user interface 150 of FIG. 13. The table 801 includes assigned characters 200 for each position of the menu 240.

The table includes values for the following variables: variable ‘menu position’ 242, variable ‘gesture to identify position’ 802, variable ‘button pressed’ 222, variable ‘swipe threshold exceeded’ 804, variable ‘button released’ 806, variable ‘ETP expired’ 808 and character 200. The table of FIG. 21 is just one possible embodiment of the user interface of FIG. 20 and the methods of FIGS. 3, 4, 5, 15A and 15B, but in alternative embodiments could include alternative character assignments, alternative assigned values for the selection buttons 110, and alternative numbers of menu positions 242 and selection buttons 110, among other possible variations.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet including but not limited to: U.S. Provisional Patent Application Ser. No. 62/276,729, entitled “METHOD OF CHARACTER IDENTIFICATION THAT USES SWIPE GESTURES” and filed Jan. 8, 2016 (Attorney Docket No. 680065.407P1), U.S. Provisional Patent Application Ser. No. 62/318,125, entitled “METHOD OF CHARACTER IDENTIFICATION THAT USES TIME DEPENDENT BUTTON PRESSES AND TIME INDEPENDENT SWIPE GESTURES” and filed Apr. 4, 2016 (Attorney Docket No. 680065.407P2), and U.S. Provisional Patent Application Ser. No. 62/334,702, entitled “ANOTHER METHOD OF CHARACTER IDENTIFICATION THAT USES TIME DEPENDENT BUTTON PRESSES AND TIME INDEPENDENT SWIPE GESTURES” and filed May 11, 2016 (Attorney Docket No. 680065.407P3), U.S. Pat. No. 8,487,877, entitled “CHARACTER SPECIFICATION SYSTEM AND METHOD THAT USES A LIMITED NUMBER OF SELECTION KEYS” and filed Jun. 10, 2010 (Attorney Docket No. 680065.401), U.S. Pat. No. 8,878,789, entitled “CHARACTER SPECIFICATION SYSTEM AND METHOD THAT USES A LIMITED NUMBER OF SELECTION KEYS” and filed Jun. 13, 2013 (Attorney Docket No. 680065.401C1), U.S. patent application Ser. No. 14/511,064, entitled “NOVEL CHARACTER SPECIFICATION SYSTEM AND METHOD THAT USES A LIMITED NUMBER OF SELECTION KEYS” and filed Oct. 9, 2014 (Attorney Docket No. 680065.401C2), U.S. Provisional Patent Application No. 61/942,592, entitled “SYSTEMS, METHODS AND DEVICES FOR INPUT OF CHARACTERS WITH OPTIONAL TIME-BASED BUTTON TAPS” and filed Feb. 20, 2014 (Attorney Docket No. 680065.404P1), U.S. patent application Ser. No. 14/627,822, entitled “SYSTEMS, METHODS AND DEVICES FOR INPUT OF CHARACTERS WITH OPTIONAL TIME-BASED BUTTON TAPS” and filed Feb. 20, 2015 (Attorney Docket No. 680065.404), U.S. patent application Ser. No. 14/701,417, entitled “METHOD OF CHARACTER IDENTIFICATION THAT USES BUTTON PRESS TYPES” and filed Apr. 30, 2015 (Attorney Docket No. 680065.40501), U.S. Provisional Patent Application No. 62/155,372, entitled “SYSTEMS AND METHODS FOR WORD IDENTIFICATION THAT USE BUTTON PRESS TYPE ERROR ANALYSIS” and filed Apr. 30, 2015 (Attorney Docket No. 680065.406P1), U.S. patent application Ser. No. 15/139,858, entitled “SYSTEMS AND METHODS FOR WORD IDENTIFICATION THAT USE BUTTON PRESS TYPE ERROR ANALYSIS” and filed Apr. 27, 2016 (Attorney Docket No. 680065.406), U.S. patent application Ser. No. 15/139,862, entitled “METHOD OF WORD IDENTIFICATION THAT USES INTERSPERSED TIME-INDEPENDENT SELECTION KEYS” and filed Apr. 27, 2016 (Attorney Docket No. 680065.408), U.S. patent application Ser. No. 15/139,866, entitled “METHOD AND SYSTEM OF MULTI-VARIABLE CHARACTER INPUT” and filed Apr. 27, 2016 (Attorney Docket No. 680065.409), U.S. patent application Ser. No. 15/139,872, entitled “METHOD OF WORD IDENTIFICATION THAT USES AN ARRAY VARIABLE” and filed Apr. 27, 2016 (Attorney Docket No. 680065.410), are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer processor-implemented method comprising:
identifying, by at least one computer processor, a character pair from among a menu of displayed characters in response to activation of a button;
if input is received, by the at least one computer processor, indicative of a swipe gesture being incorporated in the activation of the button:
determining, by the at least one computer processor, a direction of the swipe gesture; and
identifying by the at least one computer processor, a character adjacent in the menu to the character pair based on the determined direction of the swipe gesture; and
interpreting, by the at least one computer processor, the identified character or character pair as input.

2. The method of claim 1 further comprising:
acquiring, by the at least one computer processor, a sequence of interpreted characters and character pairs; and
disambiguating, by the at least one computer processor, the acquired sequence by evaluating alternative combinations of the characters and one letter from each of the character pairs in the order that the characters and character pairs are acquired to find a known word.

3. The method of claim 1 further comprising the at least one computer processor using input indicative of the duration of the button activation to unambiguously identify one character of the character pair if input is not received indicative of a swipe gesture being incorporated in the activation of the button.

4. The method of claim 3 further comprising:
the at least one computer processor using input indicative of a button activation lasting less than or equal to a particular time period to identify the character pair; and
the at least one computer processor using input indicative of a button activation lasting greater than the particular time period to identify one character of the character pair.

5. The method of claim 1 further comprising:
the at least one computer processor using input indicative of a button activation being absent an incorporated swipe gesture to identify a character dependent on a duration of the button activation; and
the at least one computer processor using input indicative of another button activation of the button incorporating a swipe gesture to identify a character independent of a duration of the other button activation.

6. The method of claim 1 further comprising the at least one computer processor using correspondence of a value assigned to the activated button with a value assigned to a position of a character in the menu of displayed characters to identify the character whose position is assigned to the value upon onset of activation of the button.

7. The method of claim 6 further comprising the at least one computer processor using input indicative of activation of the button lasting greater than a particular time period to identify a character of the character pair in a menu position one greater than the assigned value of the activated button.

8. The method of claim 6 wherein the identifying, by the at least one computer processor, a character adjacent in the menu to the character pair based on the determined direction of the swipe gesture includes:
if the at least one computer processor determines the direction of the swipe gesture is in a first direction, then identifying, by the at least one computer processor, a character in the menu at a position in the menu having an assigned value one less than the assigned value of the activated button; and
if the at least one computer processor determines the direction of the swipe gesture is in a second direction different than the first direction, then the at least one computer processor identifying, by the at least one computer processor, a character in the menu at a position in the menu having an assigned value two greater than the assigned value of the activated button.

9. The method of claim 8 further comprising the at least one computer processor interpreting character input resulting from activation of a plurality of selection buttons, including the activated button, which have assigned values that occur in increments of 3.

10. The method of claim 6 wherein the identifying, by the at least one computer processor, a character adjacent in the menu to the character pair based on the determined direction of the swipe gesture includes:
if the at least one computer processor determines the direction of the swipe gesture is in a first direction, identifying, by the at least one computer processor, a first character adjacent in the menu to the character pair; and
if the at least one computer processor determines the direction of the swipe gesture is in a second direction, identifying, by the at least one computer processor, a second character adjacent in the menu to the character pair.

11. The method of claim 1 wherein the first direction and second direction are opposing directions.

12. A character input system comprising:
at least one computer processor; and
a memory coupled to the at least one computer processor, the memory having computer-executable instructions stored thereon that, when executed, cause the at least one computer processor to:
identify a character pair from among a menu of displayed characters in response to activation of a button;
if input is received, by the at least one computer processor, indicative of a swipe gesture being incorporated in the activation of the button:
determine a direction of the swipe gesture; and
identify a character adjacent in the menu to the character pair based on the determined direction of the swipe gesture; and
interpret the identified character or character pair as input.

13. The system of claim 12 wherein the computer-executable instructions, when executed, further cause the at least one computer processor to:
acquire a sequence of interpreted characters and character pairs; and
disambiguate the acquired sequence by evaluating alternative combinations of the characters and one letter from each of the character pairs in the order that the characters and character pairs are acquired to find a known word.

14. The system of claim 12 wherein the computer-executable instructions, when executed, further cause the at least one computer processor to use input indicative of the duration of the button activation to unambiguously identify one character of the character pair if input is not received indicative of a swipe gesture being incorporated in the activation of the button.

15. The system of claim 14 wherein the computer-executable instructions, when executed, further cause the at least one computer processor to:
use input indicative of a button activation lasting less than or equal to a particular time period to identify the character pair; and
use input indicative of a button activation lasting greater than the particular time period to identify one character of the character pair.

16. The system of claim 12 wherein the computer-executable instructions, when executed, further cause the at least one computer processor to:
use input indicative of a button activation being absent an incorporated swipe gesture to identify a character dependent on a duration of the button activation; and
use input indicative of another button activation of the button incorporating a swipe gesture to identify a character independent of a duration of the other button activation.

17. The method of claim 12 wherein the computer-executable instructions, when executed, further cause the at least one computer processor to use correspondence of a value assigned to the activated button with a value assigned to a position of a character in the menu of displayed characters to identify the character whose position is assigned to the value upon onset of activation of the button.

18. The method of claim 17 wherein the computer-executable instructions, when executed, further cause the at least one computer processor to use input indicative of activation of the button lasting greater than a particular time period to identify a character of the character pair in a menu position one greater than the assigned value of the activated button.

19. The system of claim 17 wherein the identification a character adjacent in the menu to the character pair based on the determined direction of the swipe gesture includes:
if the direction of the swipe gesture is determined to be in a first direction, then the computer-executable instructions, when executed, cause the at least one computer processor to identify a character in the menu at a position in the menu having an assigned value one less than the assigned value of the activated button; and
if the direction of the swipe gesture is determined to be in a second direction different than the first direction, then the computer-executable instructions, when executed, cause the at least one computer processor to identify a character in the menu at a position in the menu having an assigned value two greater than the assigned value of the activated button.

20. The system of claim 19 wherein the computer-executable instructions, when executed, further cause the at least one computer processor to interpret character input resulting from activation of a plurality of selection buttons, including the activated button, which have assigned values that occur in increments of 3.

21. The system of claim 17 wherein the identification of a character adjacent in the menu to the character pair based on the determined direction of the swipe gesture includes:
if the direction of the swipe gesture is determined to be in a first direction, then the computer-executable instructions, when executed, cause the at least one computer processor to identify a first character adjacent in the menu to the character pair; and
if the direction of the swipe gesture is determined to be in a second direction, then the computer-executable instructions, when executed, cause the at least one computer processor to identify a second character adjacent in the menu to the character pair.

22. The system of claim 12 wherein the first direction and second direction are opposing directions.

23. A computer-readable medium having computer-executable instructions stored thereon that, when executed, cause at least one computer processor to:
identify a character pair from among a menu of displayed characters in response to activation of a button;
if input is received, by the at least one computer processor, indicative of a swipe gesture being incorporated in the activation of the button:
determine a direction of the swipe gesture; and
identify a character adjacent in the menu to the character pair based on the determined direction of the swipe gesture; and
interpret the identified character or character pair as input.

24. The computer-readable medium of claim 23 wherein the computer-executable instructions, when executed, further cause the at least one computer processor to:
acquire a sequence of interpreted characters and character pairs; and
disambiguate the acquired sequence by evaluating alternative combinations of the characters and one letter from each of the character pairs in the order that the characters and character pairs are acquired to find a known word.

25. The computer-readable medium of claim 23 wherein the computer-executable instructions, when executed, further cause the at least one computer processor to use input indicative of the duration of the button activation to unambiguously identify one character of the character pair if input is not received indicative of a swipe gesture being incorporated in the activation of the button.

26. The computer-readable medium of claim 25 wherein the computer-executable instructions, when executed, further cause the at least one computer processor to:
use input indicative of a button activation lasting less than or equal to a particular time period to identify the character pair; and
use input indicative of a button activation lasting greater than the particular time period to identify one character of the character pair.

27. The computer-readable medium of claim 23 wherein the computer-executable instructions, when executed, further cause the at least one computer processor to:
use input indicative of a button activation being absent an incorporated swipe gesture to identify a character dependent on a duration of the button activation; and
use input indicative of another button activation of the button incorporating a swipe gesture to identify a character independent of a duration of the other button activation.

28. The computer-readable medium of claim 23 wherein the computer-executable instructions, when executed, further cause the at least one computer processor to use correspondence of a value assigned to the activated button with a value assigned to a position of a character in the menu of displayed characters to identify the character whose position is assigned to the value upon onset of activation of the button.

29. The computer-readable medium of claim 28 wherein the computer-executable instructions, when executed, further cause the at least one computer processor to use input indicative of activation of the button lasting greater than a particular time period to identify a character of the character pair in a menu position one greater than the assigned value of the activated button.

30. The computer-readable medium of claim 28 wherein the identification a character adjacent in the menu to the character pair based on the determined direction of the swipe gesture includes:
if the direction of the swipe gesture is determined to be in a first direction, then the computer-executable instructions, when executed, cause the at least one computer processor to identify a character in the menu at a position in the menu having an assigned value one less than the assigned value of the activated button; and
if the direction of the swipe gesture is determined to be in a second direction different than the first direction, then the computer-executable instructions, when executed, cause the at least one computer processor to identify a character in the menu at a position in the menu having an assigned value two greater than the assigned value of the activated button.

31. The computer-readable medium of claim 30 wherein the computer-executable instructions, when executed, further cause the at least one computer processor to interpret character input resulting from activation of a plurality of selection buttons, including the activated button, which have assigned values that occur in increments of 3.

32. The computer-readable medium of claim 28 wherein the identification of a character adjacent in the menu to the character pair based on the determined direction of the swipe gesture includes:
if the direction of the swipe gesture is determined to be in a first direction, then the computer-executable instructions, when executed, cause the at least one computer processor to identify a first character adjacent in the menu to the character pair; and
if the direction of the swipe gesture is determined to be in a second direction, then the computer-executable instructions, when executed, cause the at least one computer processor to identify a second character adjacent in the menu to the character pair.

33. The computer-readable medium of claim 23 wherein the first direction and second direction are opposing directions.
